(19) United States
(12) Patent Application Publication
(10) Pub. No.: US 2012/0226594 A1
(43) Pub. Date: Sep. 6, 2012

(54) Quotes wanted in competition

(75) Inventors: Sunil G. Hirani, New York, NY (US); F. Charles Doerr, New York, NY (US); Mazyar M. Dar, New York, NY (US)

(73) Assignee: Creditex Group, Inc., New York, NY (US)

(21) Appl. No.: 11/822,029

(22) Filed: Jun. 29, 2007

Related U.S. Application Data
(60) Provisional application No. 60/817,405, filed on Jun. 30, 2006.

(51) Int. Cl. G06Q 40/00

(52) U.S. Cl. 705/37

(57) ABSTRACT

Methods and systems that facilitate the bulk execution of credit derivative transactions such as “bids wanted in competition” portfolios are disclosed. The methods include accepting from an initiating counterparty an identification of a plurality of credit default swap (CDS) contracts to be priced, providing to a plurality of dealers the identified CDS contracts to be priced, accepting bids or offers from the dealers for one or more of the identified CDS contracts, and accepting from the initiating counterparty an indication to execute one or more of the bids or offers.

### REFERENCE TO RELATED APPLICATIONS

This application claims priority to U.S. Provisional Application No. 60/817,405 filed Jun. 30, 2006, the contents of which are hereby incorporated by reference.

### FIELD OF INVENTION

This invention relates generally to methods and platforms that facilitate the bulk execution of credit derivative transactions such as “bids wanted in competition” portfolios.

### BACKGROUND OF INVENTION

Currently, conventional credit derivative markets include a user base of larger institutions. These larger institutions use the credit derivative markets for a variety of reasons. For example, commercial banks, both domestic and foreign, can obtain significant economic, regulatory, and capital relief from selling credit risk in a credit derivative market. Commercial banks can also use the credit derivative markets to add credit risk to their portfolios as an alternative to the lending market. Insurers, who typically posses excellent credit evaluation skills, primarily use the credit derivative markets to take on credit risk for a premium. Investment management companies and Hedge Funds, or other investors, use the credit derivative markets to both take on and shed risk.

The dealer community represents some of the largest financial intermediaries in the world. The dealers tend to be large, multi-national institutions that make markets in credit derivatives. The scale and scope of each dealer's credit derivative business varies widely, with some dealers having extensive credit derivative operations, and other being occasional market participants.

### SUMMARY OF THE INVENTION

Currently in the credit derivative market, institutions wishing to buy or sell credit default swap (CDS) contracts must transact directly with the dealers. To determine the best price for CDS contracts, institutions currently must go from dealer to dealer with the list of contracts to determine the best price that can be obtained for each contract. For example, there is currently the concept called Bids Wanted in Competition (BWIC). The concept of bids of Bids Wanted in Competition can be explained with respect to a hedge fund or other institutional client. A client might want to purchase, for example, 100 single name CDS contracts. Accordingly, the client will take its list of CDS contracts and will provide this list to four different dealers. Each dealer will then tell the hedge fund at what level they are willing to sell protection. They will give the hedge fund offers on each one of the CDS contracts. The hedge fund will choose who to trade with for each individual contract. There might be five with one dealer, twenty with another dealer, etc.

This current system is both time consuming and cumbersome. Accordingly, a need exists for an improved process for dealing in CDS contracts.

One embodiment of an auction method includes receiving from an initiating counterparty at least one identification of a plurality of credit default swap (CDS) contracts to be priced, providing to a plurality of dealers the identified CDS contracts to be priced, receiving bids from the dealers for one or more of the identified CDS contracts, and receiving from the initiating counterparty an indication to execute one or more of the bids.

The bids may be received from the dealers during a pricing period that is a pre-agreed period of time. The indication to execute one or more of the bids from the initiating counterparty may occur during a live period that is a pre-agreed period of time. The dealer may be able to cancel a bid after an indication to execute the bid has been accepted from the initiating counterparty. The initiating counterparty may provide a chance to one or more dealers to improve a bid for a CDS contract after bids for the CDS contract have been accepted from the dealers.

The method may also include receiving an improved bid from one or more dealers. The method may also include receiving from the initiating counterparty an indication of an end counterparty to the auction. The method may also further include sending a notice to the dealers that a list of CDS contracts to be priced has been received, prior to providing to the dealers the identified CDS contracts to be priced.

Another embodiment of an auction method may include receiving from an initiating counterparty an identification of a plurality of credit default swap (CDS) contracts to be priced, providing to a plurality of dealers the identified CDS contracts to be priced, receiving offers from the dealers for one or more of the identified CDS contracts, and receiving from the initiating counterparty an indication to execute one or more of the offers.

An embodiment of an auction system includes an administrative computing system in communication with an initiating counterparty computing system and a plurality of dealer computing systems, wherein the administrative computing system is configured to receive an identification of a plurality of credit default swap (CDS) contracts to be priced from the initiating counterparty computer system and is configured to receive bids for one or more of the identified CDS contracts from one or more of the dealer computer systems. The administrative computing system may be in communication with the initiating counterparty computing system and a plurality of dealer systems using an Internet connection.

An other embodiment of the auction system may include an initiating counterparty system comprising an initiating counterparty interface configured to receive from an initiating counterparty an identification of a plurality of credit default swap (CDS) contracts to be priced, and a plurality of dealer systems comprising a dealer interface configured to provide the identified CDS contracts to be priced and configured to receive prices from dealers for the identified CDS contracts.

### BRIEF DESCRIPTION OF THE DRAWINGS

FIG. 1 is a diagram that shows the relationship between parties on the platform.

FIG. 2 is a flow diagram that shows how an initiating counterparty initiates an auction and requests pricing from multiple dealers.

FIG. 3 is a flow diagram that details how the last look process is handled on the platform.

FIG. 4 is a flow diagram that shows that the final prices are received by the initiating counterparty on the platform.

FIG. 5 is a flow chart that shows how the trades are executed on the platform.

FIG. 6 is an example of an initiating counterparty screen prior to initiating an auction.

FIG. 7 is an example of a setup screen for loading the loading of a CDS contract list.

FIG. 8 is an example of a upload screen for uploading a CDS contract list prior to an auction.

FIG. 9 is an example of an import wizard screen for mapping fields and formatting data from an updated CDS contract list.

FIG. 10 is an example of a screen for correcting errors in the listed reference entities.

FIG. 11 is an example of a screen for correcting data errors in the uploaded CDS list.

FIG. 12 is an example of a screen that confirms that all rows in the uploaded list are valid.

FIG. 13 is an example of the final screen of the import wizard.

FIG. 14 is an example of the initiating counterparty setup screen once the CDS list is uploaded.

FIG. 15 is an example of an initiating counterparty screen during the pre-pricing period.

FIG. 16 is an example of an initiating counterparty screen during the pricing period.

FIG. 17 is an example of an initiating counterparty screen during the live period.

FIG. 18 is an example of a screen in which an individual price has been executed by the initiating counterparty.

FIG. 19 is an example of a bulk execution initiating counterparty screen.

FIG. 20 is an example of a window that allows the initiating counterparty to select how to deal with credits in which more than one dealer posted the same best price.

FIG. 21 is an example of a window in which the initiating counterparty has selected to break ties using the number of outright best prices.

FIG. 22 is an example of a window in which the initiating counterparty has selected to break ties manually.

FIG. 23 is an example of a Bulk Execute view of the initiating counterparty main auction screen.

FIG. 24 is an example of the initiating counterparty main auction screen, set to view only trades that are currently live.

FIG. 25 is an example of the initiating counterparty main auction screen, set to view only trades that are currently executed.

FIG. 26 is an example of the initiating counterparty main auction screen, set to view only trades that are not yet priced.

FIG. 27 is an example of a view of the initiating counterparty main auction screen with the Summary tab selected in the lower right corner.

FIG. 28 is an example of a view of the initiating counterparty main auction screen with the By Counterparty tab selected in the lower right corner.

FIG. 29 is an example of a view of the initiating counterparty main auction screen with the My Trades tab selected in the lower right corner.

FIG. 30 is an example of a view of the dealer screen at least 10 minutes before the start of the Pricing Period.

FIG. 31 is an example of a view of the screen when the dealer chooses the customize option.

FIG. 32 is an example of a view of the dealer screen during the pre-pricing period with less than 10 minutes to the start of the Pricing Period.

FIG. 33 is an example of a view of the dealer screen during the pricing period with the dealers prices entered but not submitted.

FIG. 34 is an example of a view of the dealer screen during the pricing period with the dealer's prices entered and submitted.

FIG. 35 is an example of a view of the dealer screen during the live period with some prices passed/cancelled by the dealer.

FIG. 36 is an example of a view of the dealer screen with an individual trade won by the dealer.

FIG. 37 is an example of a view of the dealer screen following a bulk execution and includes multiple credits won by the dealer.

FIG. 38 is an example of a view of the dealer screen listing live prices during the live period.

FIG. 39 is an example of a view of the dealer screen listing executed prices during the live period.

FIG. 40 is an example of a view of the dealer screen listing credits that have not been priced during the live period.

FIG. 41 is an example of a view of the dealer screen with the Summary tab selected in the lower right corner.

FIG. 42 is an example of a view of the dealer screen with the My Institution Trades selected in the lower right corner.

FIG. 43 is an example of a view of the dealer screen with the My Trades tab selected in the lower right corner.

FIG. 44 is an example of a view of the dealer customize window with the double confirm option checked.

FIG. 45 is an example of a trade alert window that may appear on the dealer screen after a trade has been executed with the double confirm option checked.

FIG. 46 is an example of a view of the initiating counterparty window after the execution of a trade with a dealer that has the double confirmation functionality turned on.

FIG. 47 is an example of a view of the dealer main screen after a trade has been executed with the double confirmation functionality turned on, but without the trade alert pop-up.

FIG. 48 is an example of a view of the dealer main screen shown in FIG. 47 after the dealer has clicked on a cancel button to cancel a trade.

FIG. 49 is an example of a view of the initiating counterparty screen after an executed trade has been cancelled by a dealer.

FIG. 50 is an example of a view of the initiating counterparty screen following execution of a trade with the double confirmation functionality turned off.

### DETAILED DESCRIPTION OF THE INVENTION

Definitions

Following is a list of terms used herein and their meanings:

“Administrator”: the entity or entities that manage the auction. The Administrator need not have to actively manage the auction. For example, the administrator system may simply pass information from the counterparty system to the dealers and vice versa.

“Auction”: A request by an initiating counterparty for prices in multiple credits, placed simultaneously on the platform.

“Authorized user”: See “user” below.

“Bidder: A credit derivatives dealer or market maker who inputs pricing data in the auction.

“Counterparty”: An initiating counterparty or an end counterparty.

“Cover”: The best available price for a credit that was not the executed as part of the auction.

“Credit”: A single credit default swap (CDS) contract.

“End Counterparty”: The entity designated by the initiating counterparty as the bidder's counterparty for all transactions arising out of a particular auction that either acts as principal or on a back to back basis (i.e. prime broker). The entity may be authorized to execute credit default swaps as principal or agent, as applicable, pursuant to the applicable rules and regulations in any jurisdiction in which it wishes to use the platform.

“GUI Software”: The Standard Graphical User Interface application which may be installed on initiating counterparty and dealer computers to allow access to the platform.

“Initiating Counterparty”: The entity that initiates the auction. The entity may be authorized to execute credit default swaps as principal or agent, as applicable, pursuant to the applicable rules and regulations in any jurisdiction in which it wishes to use the platform.

“Last Look”: After all of the dealers' prices have been entered, an initiating counterparty may be able to grant one or more dealers who did not have the best price a chance to improve their bid or offer.

“Last Look Period”: The period of time during which dealers who have been granted a last look are able to enter a new last look price.

“Live Period”: A period of time during which all prices entered by the bidders may be executed by the initiating counterparty.

“Notional”: The calculation amount of protection being bought or sold.

“Official Trade Record”: The electronic record created by the platform, indicating that a transaction has been completed.

“Platform”: The electronic matching platform and underlying Quotes Wanted in Competition (Q-WIXX) system.

“Price”: The actionable bid or offer, placed on the platform by a Bidder in response to an auction and that is executable at any time during the live period.

“Pricing Period”: A pre-agreed period of time, specified by the initiating counterparty, during which dealers are able to enter prices for an auction.

“Prime Broker”: A credit derivatives dealer or market-maker intermediating transactions between dealers and initiating counterparties.

“Q-WIXX/Quotes Wanted In Competition”—a system for allowing an initiating counterparty to receive bids or offers for CDS contracts from multiple dealers.

“Transaction”: A legally binding obligation between a dealer and an Authorized Counterparty as a result of the use of the platform.

“T-ZERO”: A post-transaction system for transaction capture, acknowledgement and processing provided by T-Zero Processing Services LLC or its affiliate.

“User” or “Authorized user”: An individual at a dealer or counterparty authorized by that dealer or counterparty to access the platform (and where required by local law or regulation, who is licensed or approved by the applicable regulatory authority), who may have been provided a login and password by the administrator to enter the platform.

The disclosed methods and platform facilitate the bulk execution of credit derivative transactions such as “bids wanted in competition” portfolios.

Auctions can be created by initiating counterparties. An auction may include two or more distinct periods of time including the pricing period and the live period.

The initiating counterparty will typically issue a CDS contract list and contributing dealers will put their prices into the list. The platform can make it easy for the initiating counterparty to figure out who has the best price. Administrators can be made available to make sure that things run smoothly, make sure that the software is installed properly, and that users have a user account etc. The trades can occur on the platform. They can then be fed to a system such as T-ZERO, which can feed them into the Depository Trust & Clearing Corporation (DTCC) system for execution. Alternatively a list of executed transactions can be downloaded from the platform.

The initiating counterparty, dealer, and administrative systems may include one or more applications for implementing the disclosed methods. For example, GUI Software can be installed on the computer systems of the initiating counterparty and the dealers. The computer system running the GUI software or the administrative software may include, for example, a PC with a Pentium/1.0 GHz or higher microprocessor, running Microsoft WINDOWS, and having a connection to a network, such as the Internet. The Internet connection allows for communication between computers operated by the initiating counterparty, the administrators, and the dealers. The initiating counterparty application may be the same as or different than the dealer application.

The platform allows the initiating counterparty to upload the list of CDS contracts they want in the auction. It is also possible that different requests for prices can be sent to different dealers or even to different people within the dealers. For example, a dealer may have ten traders; three who are brokers in autos, a two in financial, etc. The requests for quotes can then be delivered directly to the different traders who handle the relevant credit default swaps.

The initiating counterparty interface may include a list of names that are broken down by sector. For example, the initiating counterparty interface includes prices for the dealers as they come in next to one another and the best price is indicated there.

The initiating counterparty may have the ability to choose a dealer other than the one with the best price. For example, even if a dealer has the worst price, the initiating counterparty can still choose that dealer for various reasons. For example, they might have a better relationship with that specific dealer.

The dealer interface may include a list of the CDS contracts and an area where they can enter their prices. The system may include one or more additional views for different people at the dealers. For example, many dealers have flow desks which are involved in market making but do not interact directly with the initiating counterparties. Typically, people at the dealer who deal with the initiating counterparties are at the sales desk. The sales people then call the flow desks and ask how much to quote the initiating counterparties for each CDS contract. The dealer interface may include several different views that allow for the relevant CDS contract information to be delivered directly to the right people at the dealer. For example, the sales desk view may allow for the sales desk to see all of the information for the dealer, but may not allow for the entry of prices. A complete trader view may allow for a trading desk to view all of the information for the dealer and all for the entry of prices. Additional trader views may only show CDS contracts related to a specific flow desk. In this manner, the flow desk related to a specific industry may only be able to see and price contracts related to their industry.

There may also be an administrator's view. This view may include all of the information seen by the initiating counterparty, but may or may not limit what can be changed. For example, this view may include who is in the auction, who got invited, and who has put in prices. The administrator's view may also include information not in the initiating counterparty or dealer views for confidentiality and conflict of interest purposes.

When the initiating counterparty initiates an auction, the initiating counterparty may specify the times for each period, the dealers that will be invited to the auction, the name of any end counterparty in the auction, and the identification of the CDS contracts in the auction portfolio.

A minimum time period, for example 20 minutes, may be provided for the pricing period. A maximum time period, for example 10 minutes, may be provided for the live period.

The initiating counterparty may provide the economic details associated with each credit included in the auction portfolio. These details may also be uploaded from a file, for example an EXCEL file. Within the uploaded file, the initiating counterparty may specify reference entity, notional, reference obligation ISIN, reference obligation, target price (optional and only visible to the initiating counterparty) and maturity date. All other details can automatically be derived from market standards and RED data, including, where applicable, the RED pair clip. RED data may only be available to those institutions with a current RED data license.

The administrator may also require that an auction comply with one or more other criteria. For example, a particular auction may be only bids, or only offers. Alternatively, an auction may include both bids and offers. An auction may also require a minimum and/or maximum number of CDS contracts, a minimum notional per credit, a minimum increment per credit, and no duplicate credits.

The platform may notify the dealers prior to the start of an auction. For example, 10 minutes prior to the start of the auction, an automatic email notification may be generated to dealers as well as to the end counterparty (if specified). Prior to the start of the auction, each dealer may be able to view that there is a scheduled auction in which its institution has been asked to participate. Each pending auction may, for example, appear as a tab within the dealer application, and may display the start time of the auction. Each dealer may also be able to see one or more of the following information: initiating counterparty name, end counterparty name (if applicable), salesperson at the dealer associated with end counterparty, auction start time, auction name, number of credits in the auction, total notional in the auction, and the number of dealers in auction.

At the start of the pricing period, all dealers may be able to see the entire list of credits on the platform. Nonstandard market information may be highlighted to the initiating counterparty as well as dealers. Pricing access may be controlled on a user-by-user basis at each dealer. Access to the credits may be on a sector-by-sector basis.

During the pricing period, prices may only be seen by the dealer entering the price. All users may be able to see prices entered by their institution subject to being appropriately permissioned. Dealers may not be obligated to enter prices for all credits. Accordingly, a dealer may choose to actively pass on an individual credit. This action is communicated to the initiating counterparty at the end of the pricing period. Dealers may amend or cancel prices at any time during the pricing period. The initiating counterparty may not be able to see that a price is being amended or cancelled.

If more than one user from the same dealer has access to enter prices for a given credit, then the price displayed can be the last price entered on the platform. The initiating counterparty might not see any prices until the end of the pricing period. Dealers may have the option to confirm their prices before they are displayed to the initiating counterparty on the platform.

During the live period, the initiating counterparty may execute against any price submitted during the pricing period by the dealers. However, in some auctions it may be possible to specify that the initiating counterparty must execute against the best price.

In some auctions the initiating counterparty may not ask for improvements. However, in other auctions it may be possible for the initiating counterparty to ask for improvements, by for example, granting a last look, as described herein. The dealers may cancel all or some of their prices during the live period. However, dealers may not be able to repost a price for any credit during the live period.

The platform may allow the initiating counterparty to execute against any of the prices with any dealer, at its sole discretion, at any time before the end of the live period. In some embodiments, a price must be executed for the full notional displayed on the platform. The initiating counterparty may be able to withdraw from the process at any point at its sole discretion. The initiating counterparty may be only able to execute against one price per credit.

Following an auction, a summary of the auction may be made available to each dealer or counterparty (as applicable) who participates in that auction. The initiating counterparty may be provided all prices and passes, all price cancellations (pre and post execution), all transactions, the best price average per sector, the best price average for the whole auction, and the hit ratios by counterparty and sector.

If the dealer did not enter a price for a given credit, it may not be able to receive information regarding whether a transaction was completed or not. If a dealer entered a price for a credit, then it may be provided with information that may be dependent upon the price they submitted. For example, if they were the best price for a credit, they may be able see whether the credit was traded or not, that they were the best price, and how much better its price was than the cover (the second best price). Further, the cover may be able to see if the credit was traded or not and that it was the cover. The platform may restrict other dealers from seeing whether the credit was traded or not.

In addition, dealers may be able to see on a sector basis the number of transactions in each sector, the number of transactions completed (regardless of whether the dealer provided the price that was executed), and the number of transactions in that sector that their institution has won. This information may be available either as the number of transactions or as a percentage of the transactions in each sector.

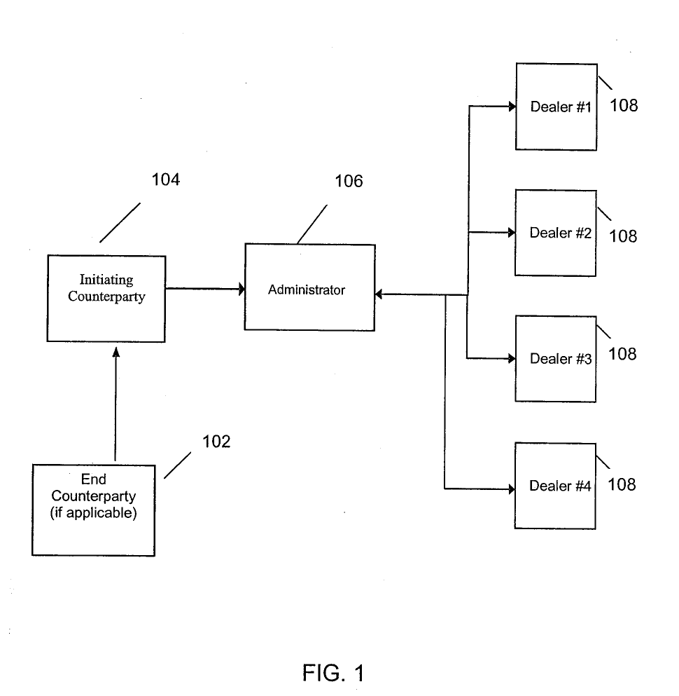

FIG. 1 shows the relationship between parties on the platform. In FIG. 1, an end counterparty 102 can contract an initiating counterparty 104 to handle an auction on behalf of the end counterparty. The initiating counterparty then submits the details for the CDS contract auction to multiple dealers 108 using the platform maintained by administrator 106. By having an administrator 106 act as an intermediary, the initiating counterparty can submit the information for the auction at one time and have the information distributed to all of the dealers 108 at the same time. Further, the dealers 108 can submit their bids or offers to the administrator 106 and have this information provided to the initiating counterparty 104 in an organized and discreet manner.

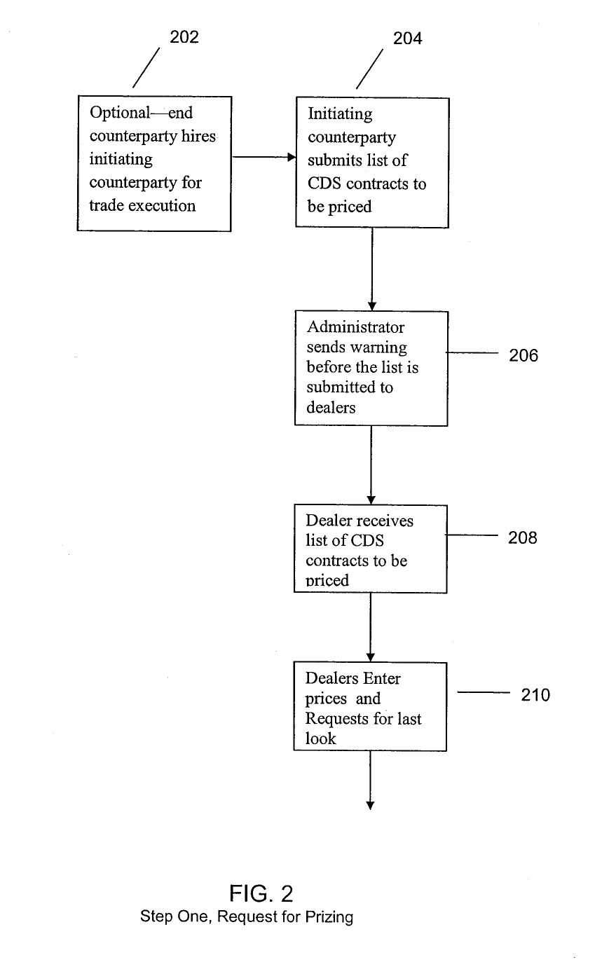

FIGS. 2-5 are flow diagrams that detail how the arrangement in FIG. 1 is utilized by the platform. FIG. 2 shows how an initiating counterparty initiates an auction and requests pricing from multiple dealers. The initiating counterparty can initiate an auction on its own behalf or on the behalf of an end counterparty. For example, the end counterparty can hire the initiating counterparty prior to the auction at 202 to handle the auction. A separate end counterparty will not exist for auctions in which the initiating counterparty is the end counterparty.

To initiate the auction, the initiating counterparty first submits a list of CDS contracts to be priced on the platform to the administrator at 204. The administrator then sends a warning that notifies the dealers that a list of CDS contracts to be priced will be appearing shortly at 206. This warning may, for example, be sent out 10 minutes prior to submitting the list to the dealers. The initiating counterparty may be given the option to cancel the auction before the warning is sent to the dealers at 206.

The dealers then receive the list of CDS contracts to be priced at 208 through the platform. Once the dealers receive the list of CDS contracts to be priced, the dealers can enter their prices into the platform during the pricing period at 210. The pricing period may be any pre-agreed amount of time, for example, greater than 20 minutes. During the pricing period the dealers may also request a last look. By requesting a “last look,” the dealer is asking the initiating counterparty for a chance to improve their price for a given CDS contract after the close of the pricing period if they do not submit the best price for the contract.

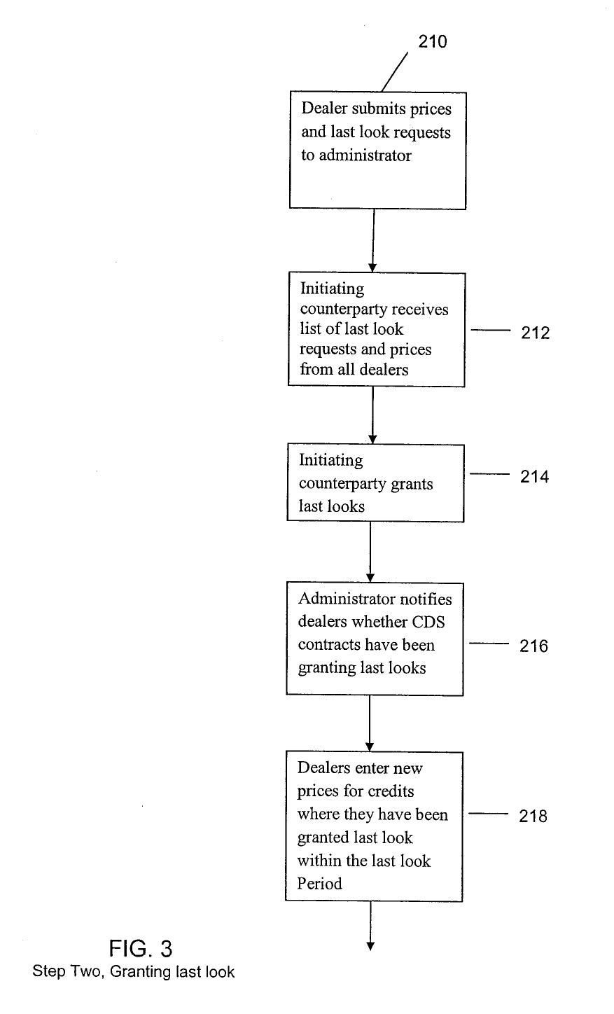

FIG. 3 details how the last look process is handled on the platform. In FIG. 3, once the dealers enter the prices and last look requests at 210, the initiating counterparty then receives from the administrator a list of last look requests and prices submitted by the dealers at 212. The initiating counterparty can then grant one or more dealers who requested a last look and who did not have the best price for a given CDS contract the chance to improve their price at 214. In one embodiment, if the dealer who submitted the best price requested a last look for the CDS contract, then no dealer can be given a last look for this contract. If one or more dealers are given a last look, the administrator notifies these dealers at 216. The dealers that have been granted last looks then enter new prices for the CDS contracts during a last look period at 218. The last look Period is a predetermined period of time.

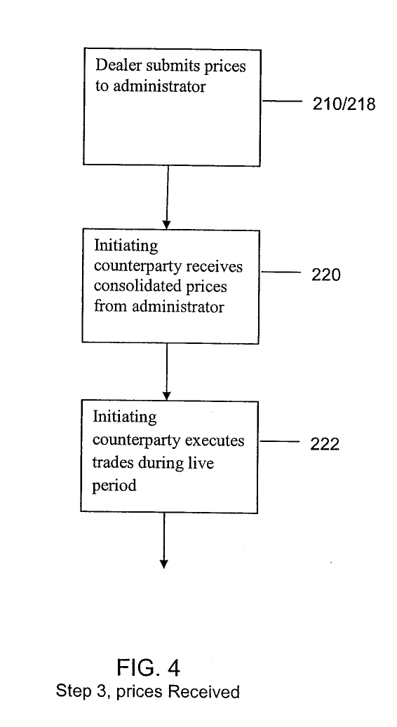

FIG. 4 details how the final prices are received by the initiating counterparty on the platform. The dealers submit their prices to the administrator using the platform at 210 and 218. The initiating counterparty then receives a consolidated list of prices from the administrator at 220. The initiating counterparty can then choose which trades to execute during the live period at 222.

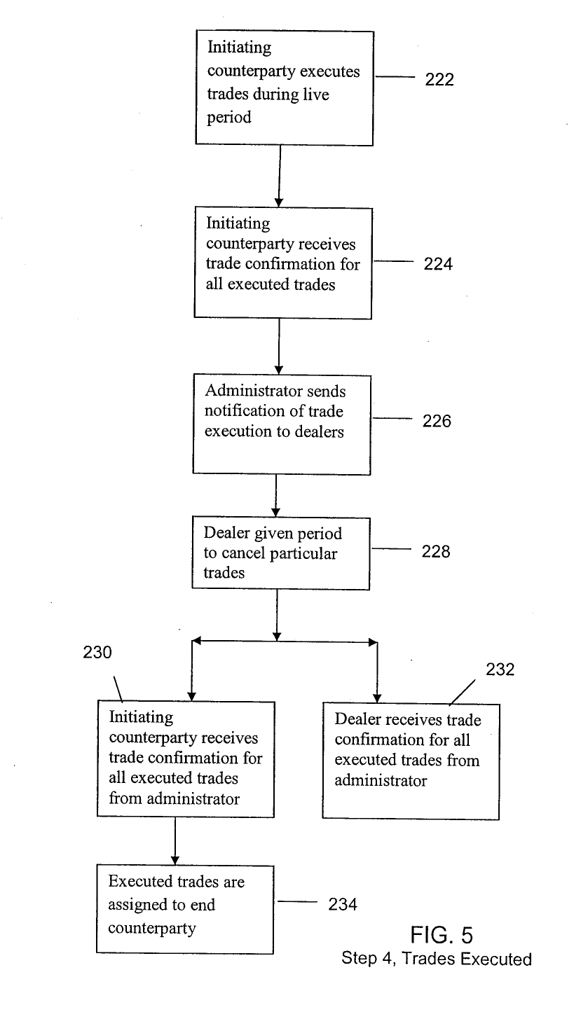

FIG. 5 details how the trades are executed on the platform. In FIG. 5, the initiating counterparty executes trades during the live period at 222. The initiating counterparty then receives a trade confirmation for all executed trades from the administrator at 224. The administrator also sends a notification of the trade execution to the dealers who have won the auctions at 226. The dealers may be given a predetermined period of time to cancel particular trades at 228. In this manner, the dealer is given a last chance to back out of a trade if, for example, the dealer determines that a price was entered in error. If a dealer backs out of a trade, the initiating counterparty may be given the opportunity to accept the next best price. Once the period in 228 has past, the initiating counterparty receives a trade confirmation for all executed trades from the administrator at 230. At the same time, each dealer receives trade confirmation for all of their executed trades from the administrator at 232. Finally, the executed trades are assigned from the initiating counterparty to any end counterparty at 234.

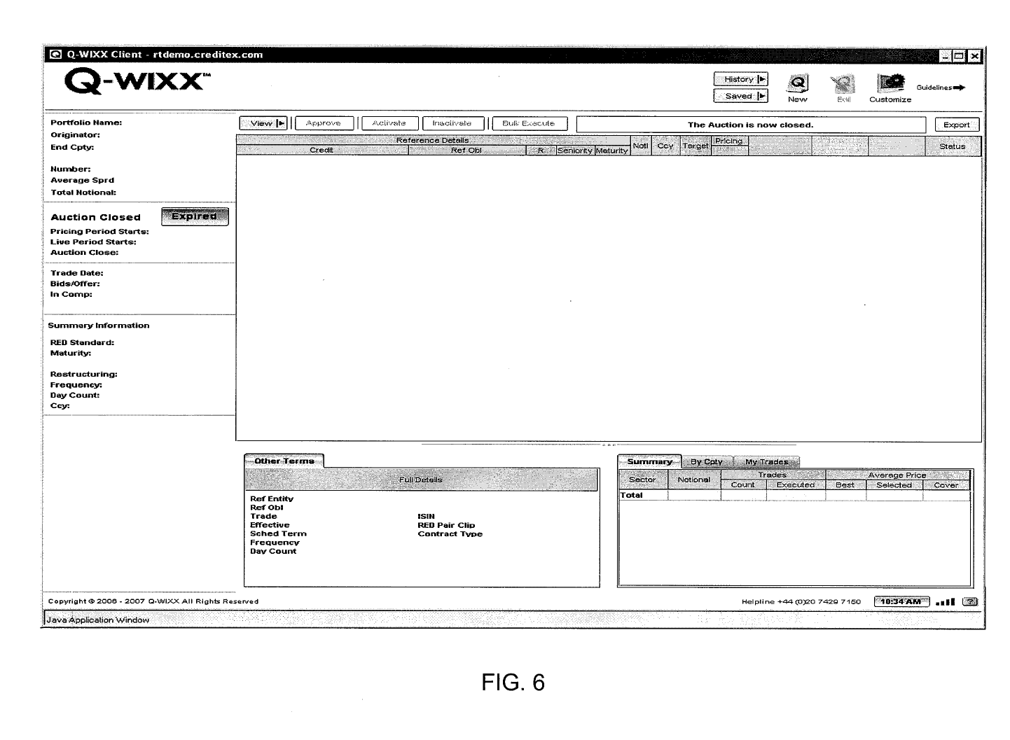

The different platform interfaces for each of the parties described with respect to FIG. 1 will now be described. FIGS. 6-50 show views of an initiating counterparty system and dealer system utilizing an embodiment of the platform. These screen views are intended to be only illustrative and are not intended to limit the invention to only the illustrated configurations.

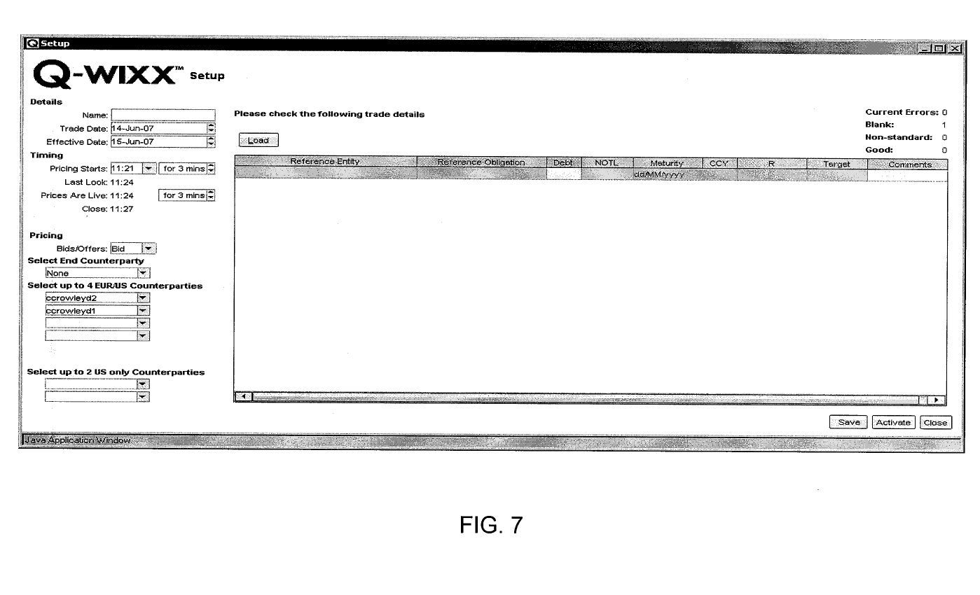

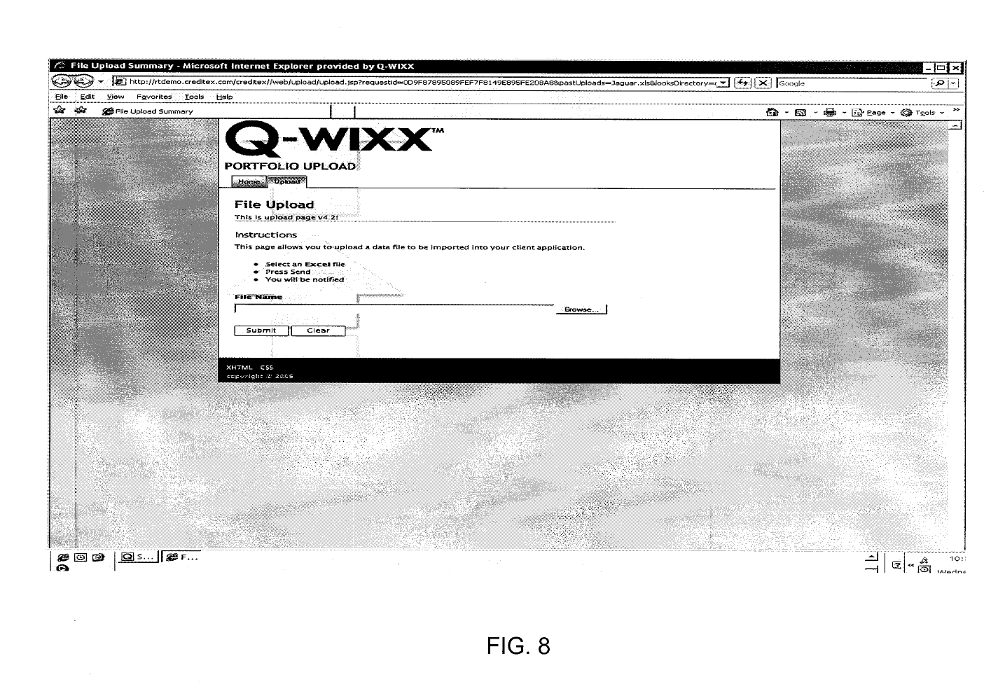

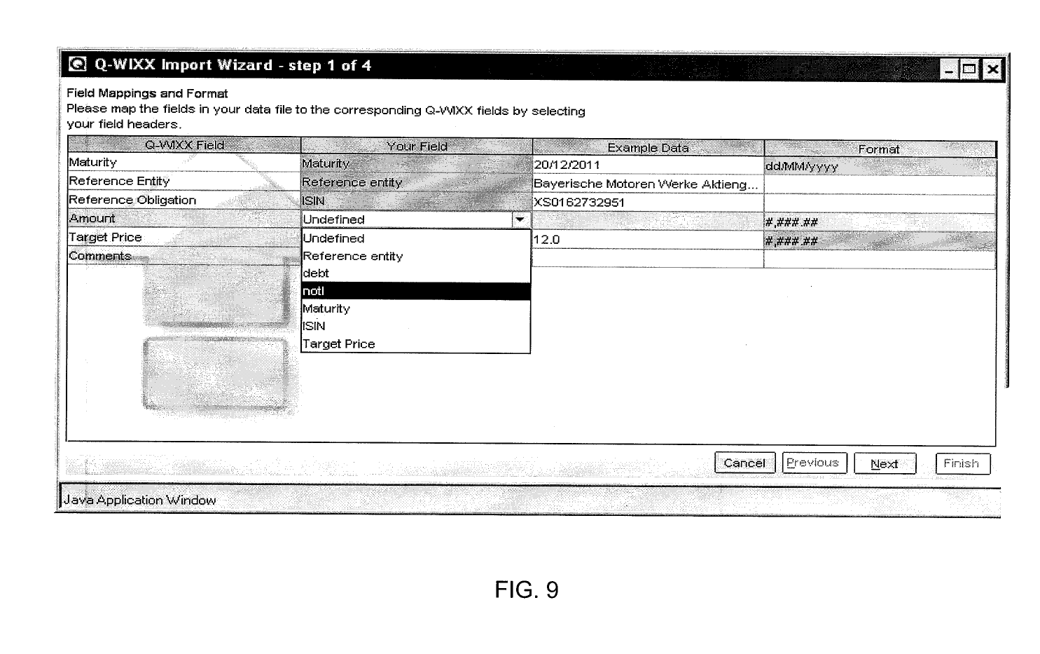

FIG. 6 an example of an initiating counterparty screen prior to initiating an auction. FIG. 7 shows an example of a setup screen for the loading of the CDS contract list. The CDS contracts may be loaded onto the platform manually one at a time or the CDS contracts can be uploaded in list format. FIG. 8 shows an example of an upload screen for uploading a CDS contract list prior to an auction. In FIG. 8, files are uploaded onto the platform from the initiating counterparty's system in EXCEL format; however, in different embodiments, additional or alternative file formats may be utilized. Once the CDS contract list is uploaded into the system, the initiating counterparty may indicate which fields in the list correspond to data utilized by the platform. FIG. 9 shows an example of an import wizard screen for mapping fields and formatting data from an updated CDS contract list. In FIG. 9, the initiating counterparty maps the names of their column headers to names that the platform recognizes. The initiating counterparty CDS list may include one or more of the contract's maturity, reference entity, reference obligation, and amount. In addition, the CDS contract's target price and any comments may be included.

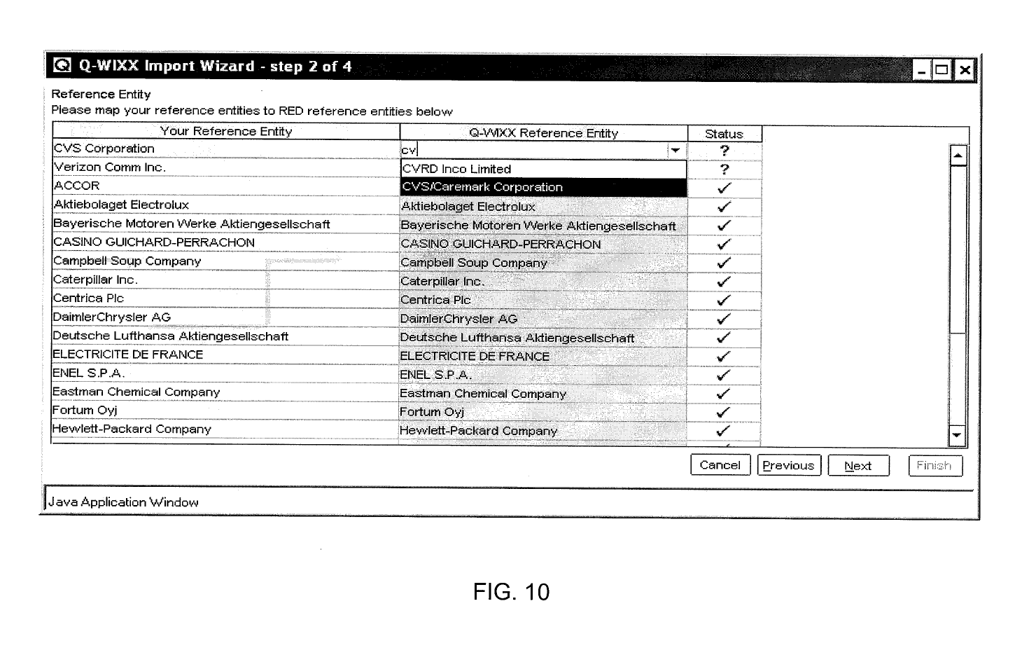

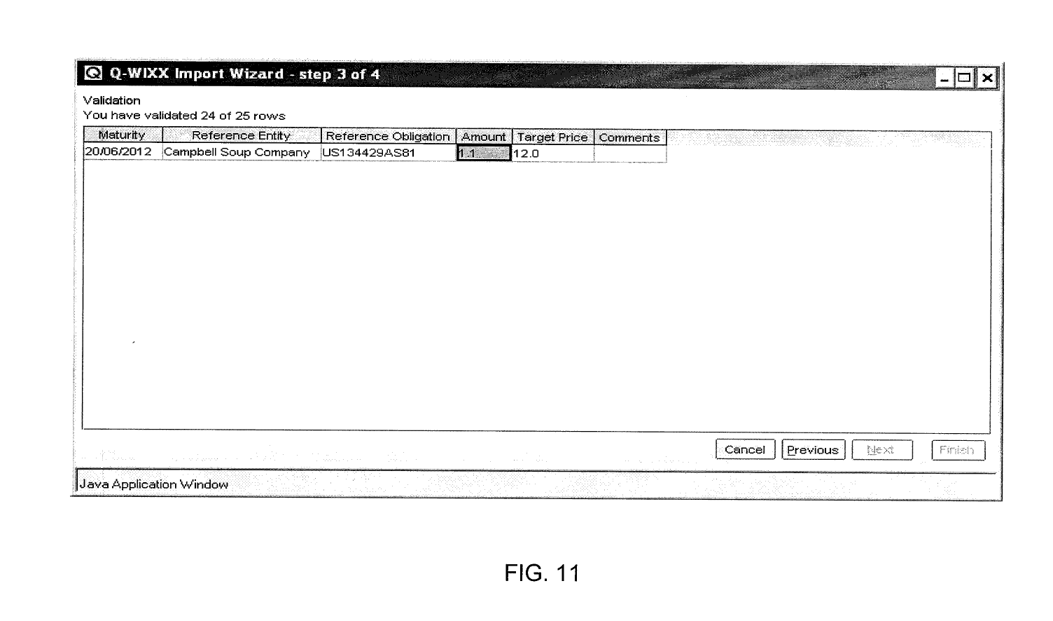

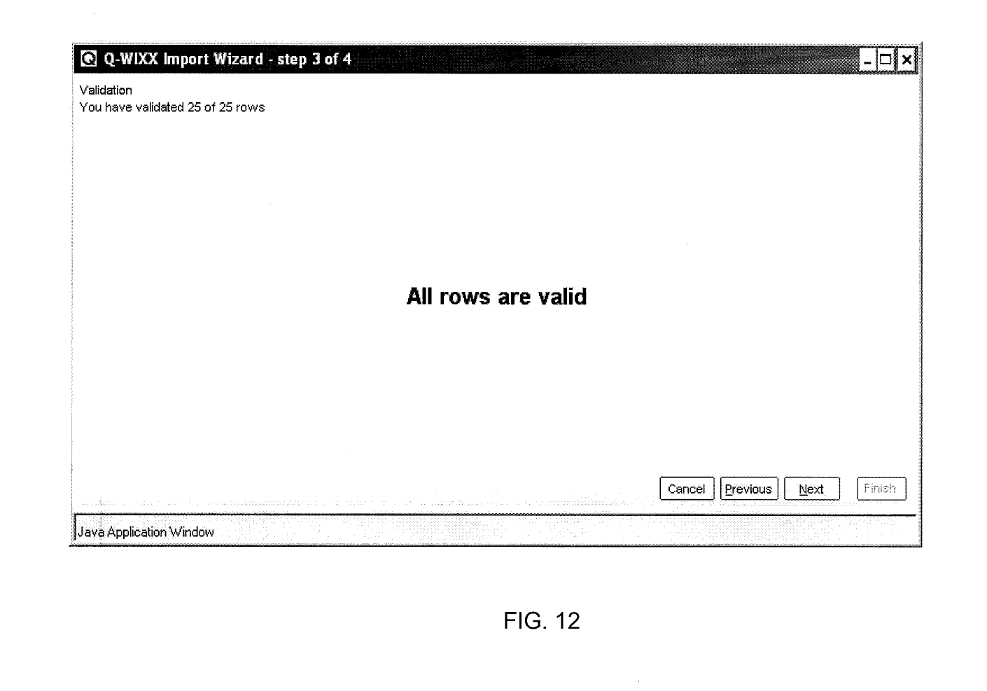

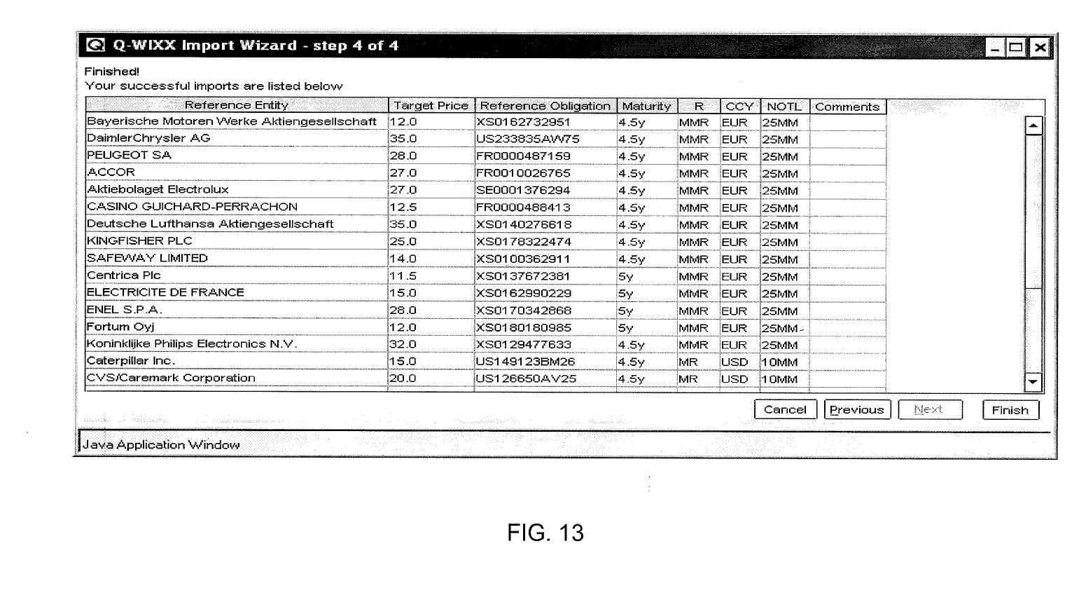

Once the CDS list is mapped, the platform may allow the initiating counterparty to correct any errors in the CDS list. FIG. 10 shows an example of a screen for correcting errors in the listed reference entities. The platform may identify errors by comparing the uploaded list with a database of known and valid reference entities. All uploaded reference entities may be matched to one of the reference entities in the database before the auction can start. This can ensure that only reference entities that the market in general will recognize and accept are used. FIG. 11 shows an example of a screen for correcting data errors in the uploaded CDS list. The platform may request that all errors in the upload file are corrected at this point. Examples of errors could include missing data (e.g. a blank reference obligation) or data that does not meet the protocol requirements (e.g. the minimum amount in FIG. 11). FIG. 12 shows an example of a screen that confirms that all rows in the uploaded list are valid. The platform may be able to obtain missing information from the reference entity database that may be part of the platform. For example, FIG. 13 shows an example of the final screen for the import wizard. The Platform may map Restructuring (“R”) and Currency (“CCY”) and RED Pair Clip (if the user has a valid RED license) from the market standard trading information it holds in the database.

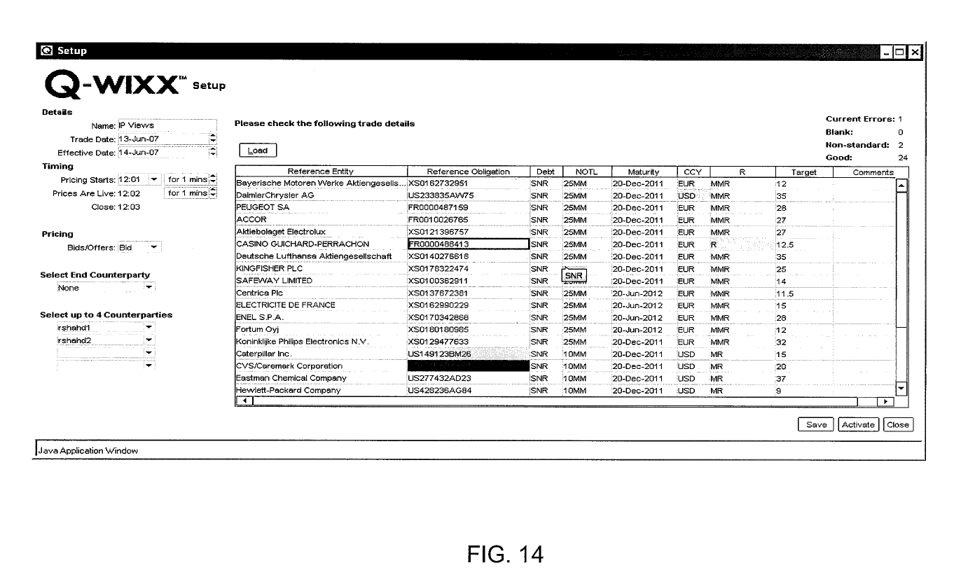

FIG. 14 shows an example of the initiating counterparty setup screen once the CDS list is uploaded. The screen in FIG. 14 includes the auction name, auction date, and effective date of any contracts executed in the auction. The screen also includes the time at which the auction will open. The initiating counterparty may provide a minimum amount of notice before an auction occurs. For example, they may provide at least 10 minutes notice that an auction is going to occur. The dealers can then be invited to the auction by email before the auction starts. Dealers that have their platform open before the auction is due to start may see the platform dealer screen pop-up at that time.

The setup screen may also include the length of time that dealers have to input their prices, for example, a minimum of 20 minutes, and the length of time the initiating counterparty has to execute trades, for example, a maximum of 10 minutes. The initiating counterparty may ask dealers to buy protection (“Bid”) or sell protection (“Offer”) on the platform. Initiating counterparties may be able to co-mingle bids and offers. In this case an extra column (not shown) may be included that specifies bid or offer for each reference entity.

In FIG. 14, if the initiating counterparty is acting as agent on behalf of an end counterparty, they can specify this on this screen. The initiating counterparty may be required to select an end counterparty before they can select the dealers that they invite to attend the auction. This is because dealers may have different credit line limits for a counterparty depending on whether they initiate an auction or simply act as the end counterparty. The initiating counterparty can select the dealers that they wish to invite to the auction. In FIG. 14, the platform allows for the selection of four dealers to respond to both US and European credits and then an extra two dealers that may respond to U.S. credits only.

In FIG. 14, the portfolio summary status indicates how many errors exist in the portfolio at this stage that should be fixed before the auction is activated. The number of blank fields and the number of non-market standard fields are also indicated.

The main table in FIG. 14 may be color coded. For example, a blue cell background may indicate that the cell can be edited, and a yellow cell background may indicate that data are valid, but not the standard the market usually trades. If the reference obligation column uses the RED database run by MARKIT, additional color coding may applying. For example, a white cell background with red text can indicate an error that must be fixed before the auction can be activated, a blue cell background can indicate a RED preferred obligation, a yellow cell background can indicate the reference obligation is in RED, but not a preferred obligation, and a red cell background can indicate that the obligation is in the platform database, but not in the RED database.

The screen in FIG. 14 also includes a save button to save an auction for use at a later date, and an activate button. If an auction has been validated successfully by the platform, then the activate button can be used to start the countdown to the beginning of the auction.

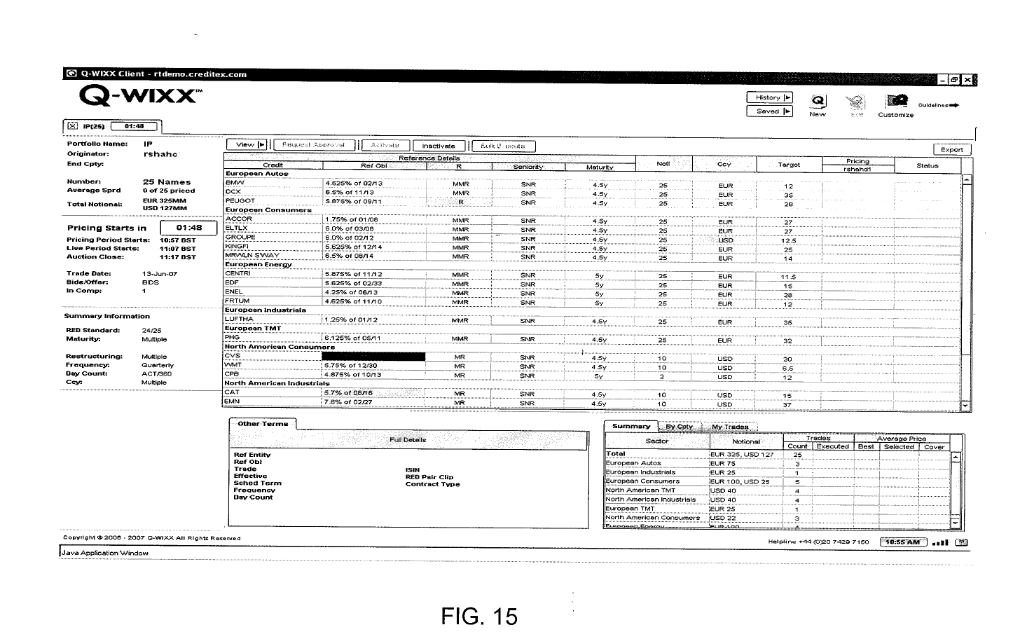

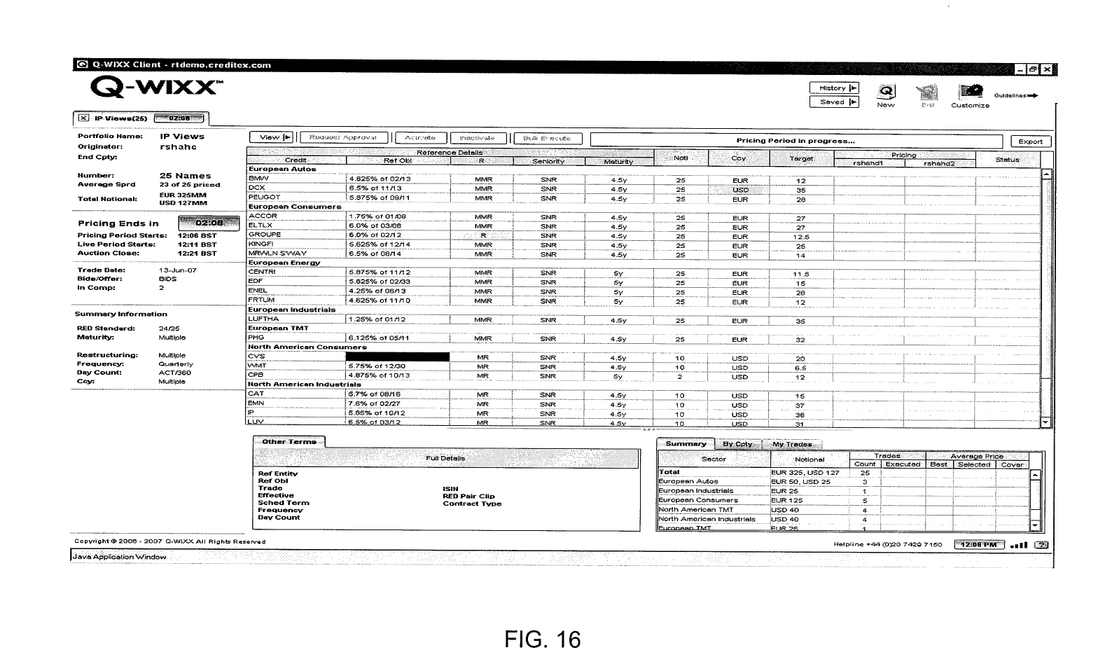

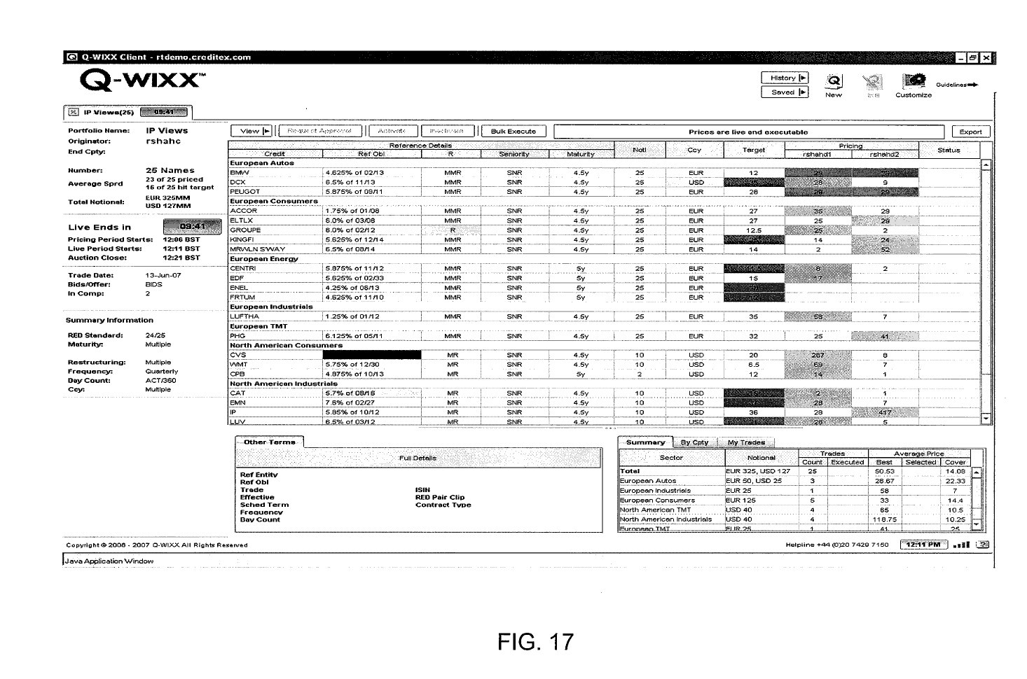

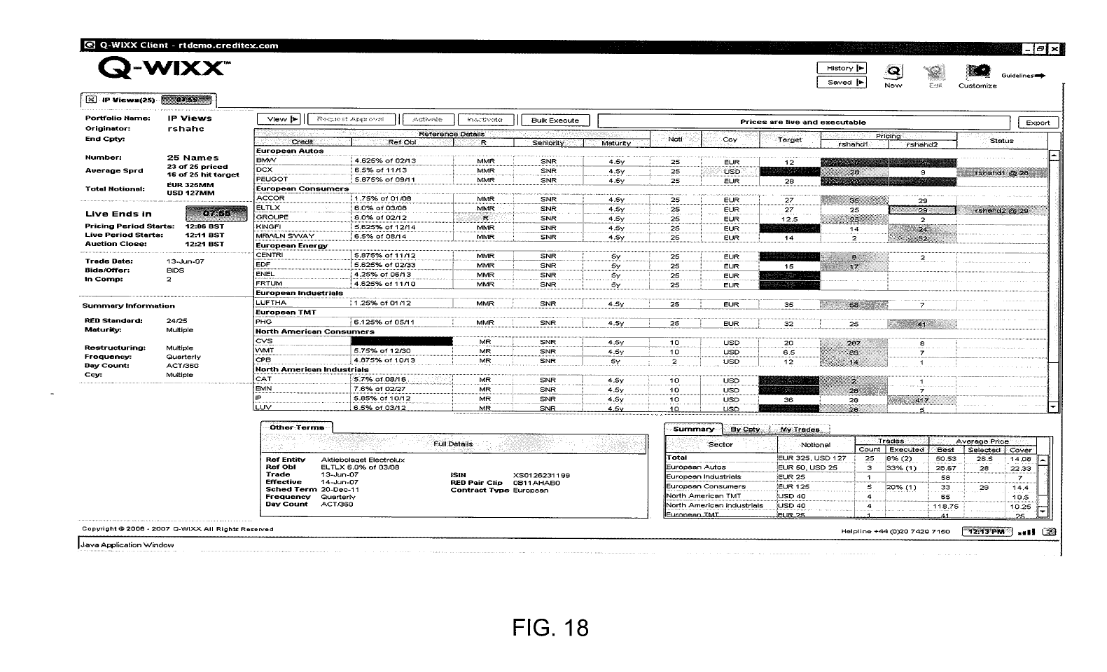

FIG. 15 shows an example of an initiating counterparty screen during the pre-pricing period. FIG. 16 shows an example of an initiating counterparty screen during the pricing period. FIG. 17 shows an example of an initiating counterparty screen during the live period. During the live period, the prices are executable by the initiating counterparty. FIG. 18 shows how individual prices can be executed by the initiating counterparty. To execute a price, the initiating counterparty selects the price they want to execute under a dealer's name.

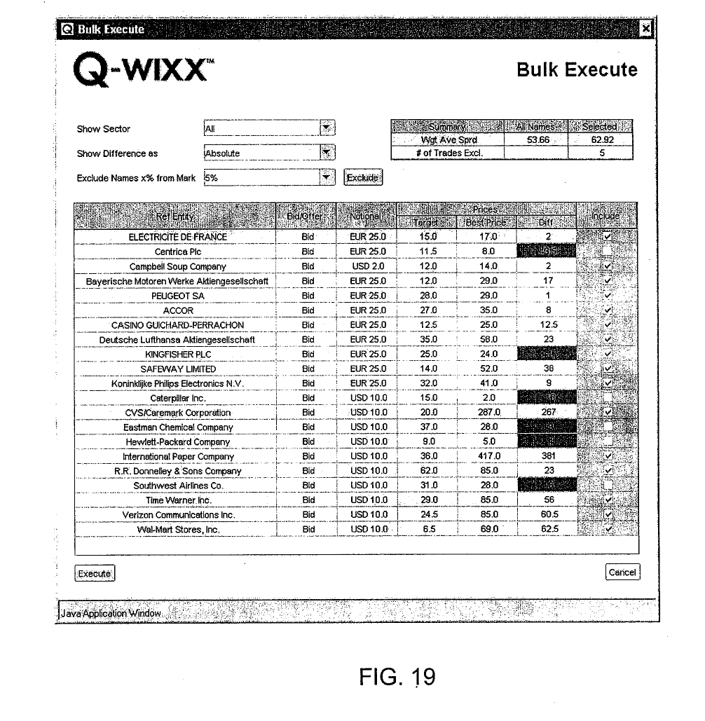

During the live period, the initiating counterparty may be able to choose a bulk execution option that allows the initiating counterparty to execute several trades simultaneously. FIG. 19 shows an example of a bulk execution initiating counterparty screen. On this bulk execution screen, the initiating counterparty is given the chance to select unexecuted credits by sector. The initiating counterparty may also choose to show the difference between the target price and the best price as either an absolute difference in basis points or as a percentage difference. Further, any credits that are more than a predetermined percent away from the target price may automatically be excluded from the bulk execution.

The bulk execution screen shown in FIG. 19 also shows the weighted average spread of all possible trades, and that of the trades that are currently included in the bulk execute. The number of trades that are currently being excluded is provided. In addition, basic information about each of the credits is shown. For example, whether the credit is currently included in the list to bulk execute or not is indicated. A red cell background or other indication can be used indicate that the best price for a credit has not reached the target level. Finally, a button to start the bulk execution is provided.

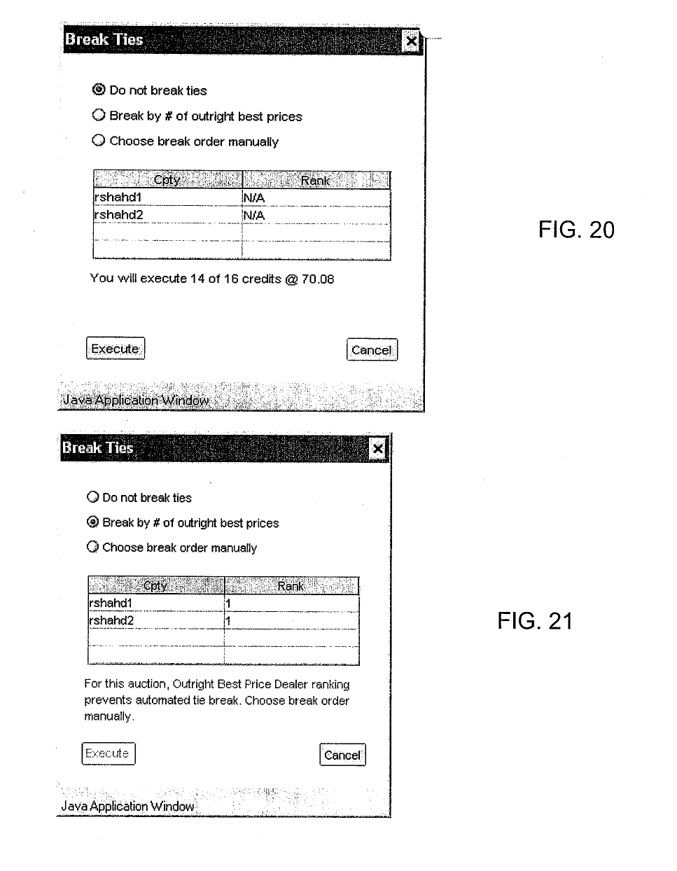

Once the bulk execution button is selected, additional windows may be used to provide additional information on how to implement the bulk execution. For example, FIG. 20 provides a window that allows the initiating counterparty to select how to deal with credits where more than one dealer posted the same best price. In this example, the initiating counterparty has selected not to execute any trades where more than one dealer submitted the best price.

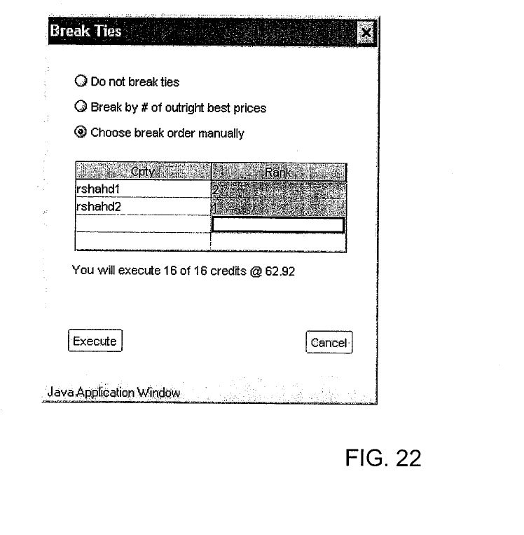

FIG. 21 shows a window in which the initiating counterparty has selected to break ties using the number of outright best prices. According to this method of breaking ties, the platform calculates a ranking for each dealer based on the number of credits where they submitted the outright best price (i.e. not tied for best price with another dealer). The dealer with the most outright best prices is ranked 1, second most 2, etc. In the event of a tie, the trade is awarded to the dealer with the lowest ranking.

FIG. 22 shows a window in which the initiating counterparty has selected to break ties manually. According to this method of breaking ties, a manual ranking is assigned to each of the dealers. The dealer with the lowest (best) ranking is awarded the trade.

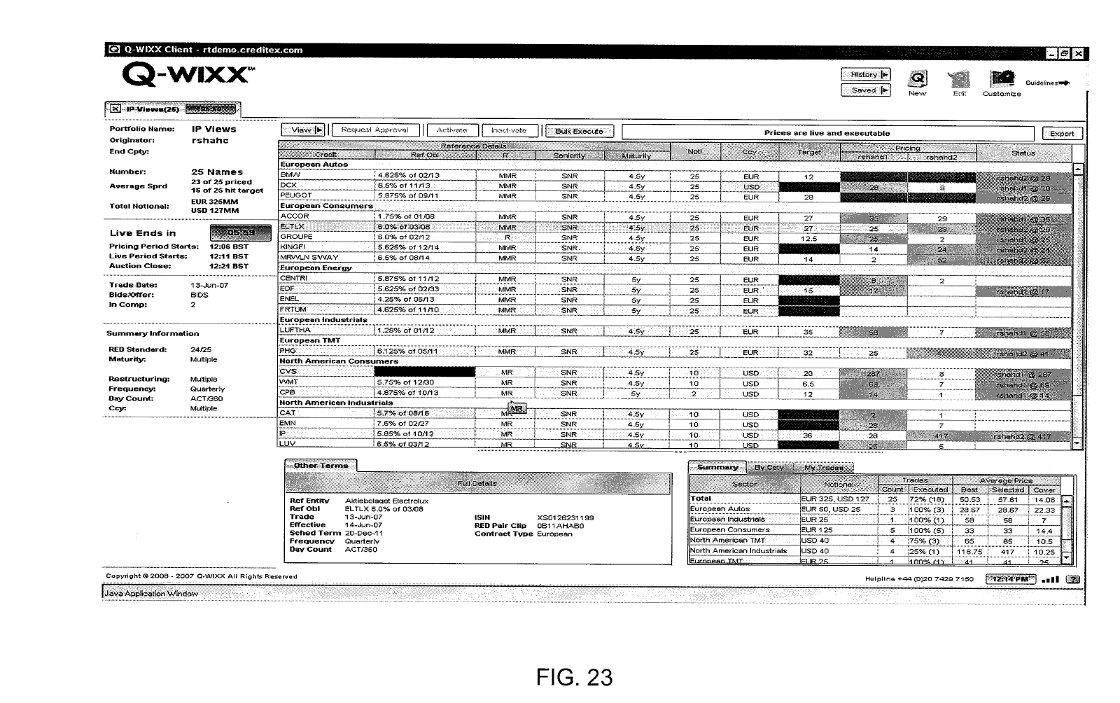

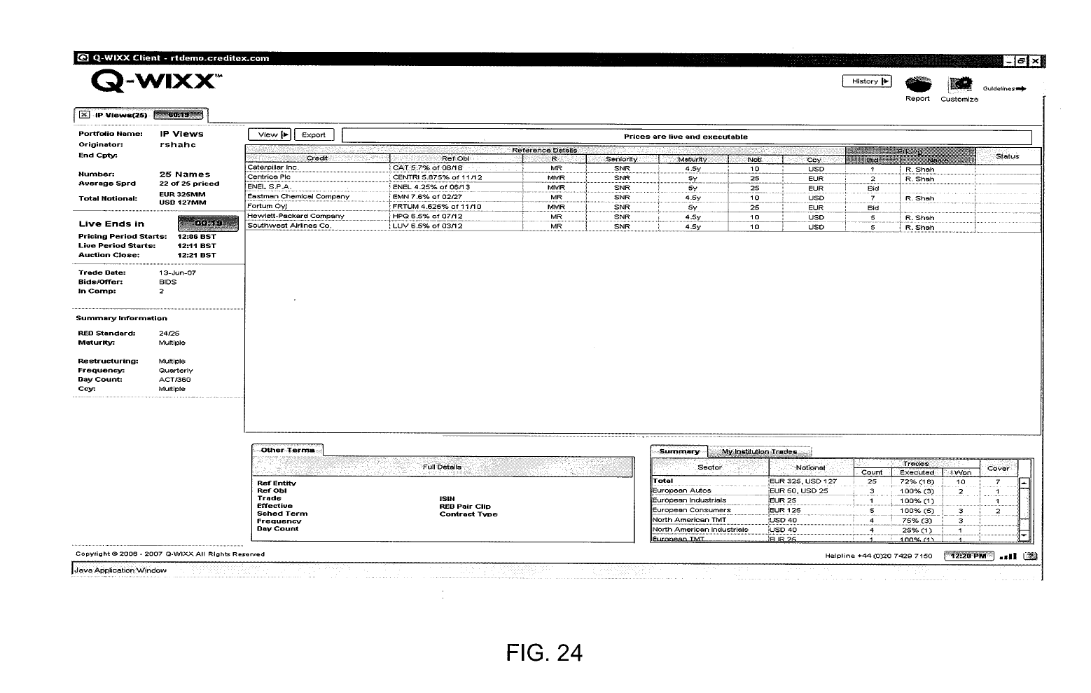

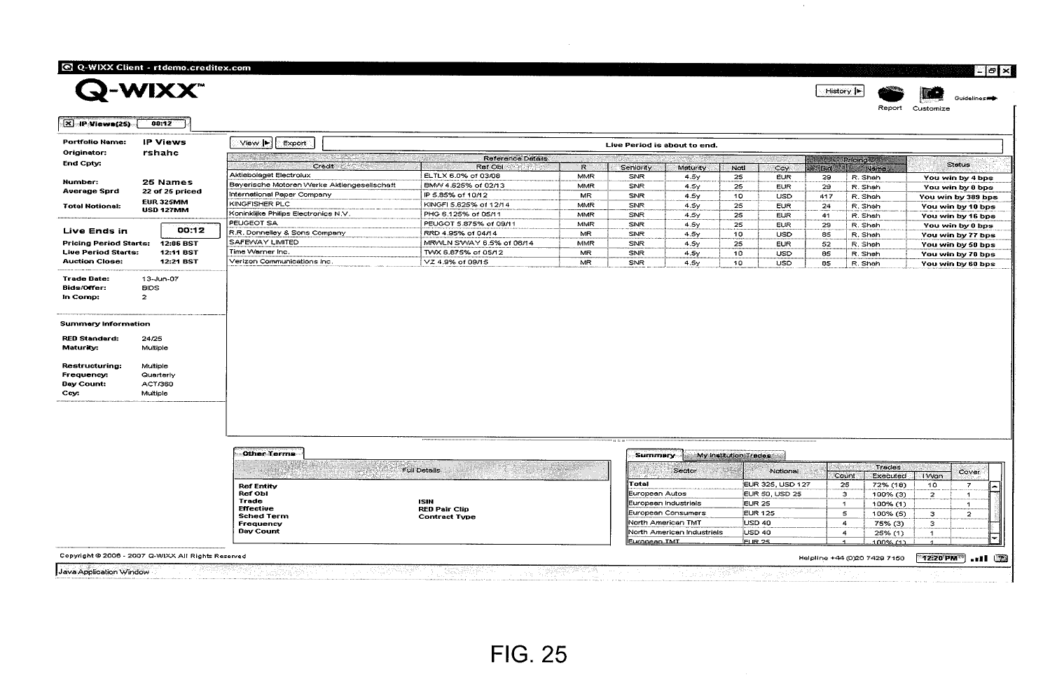

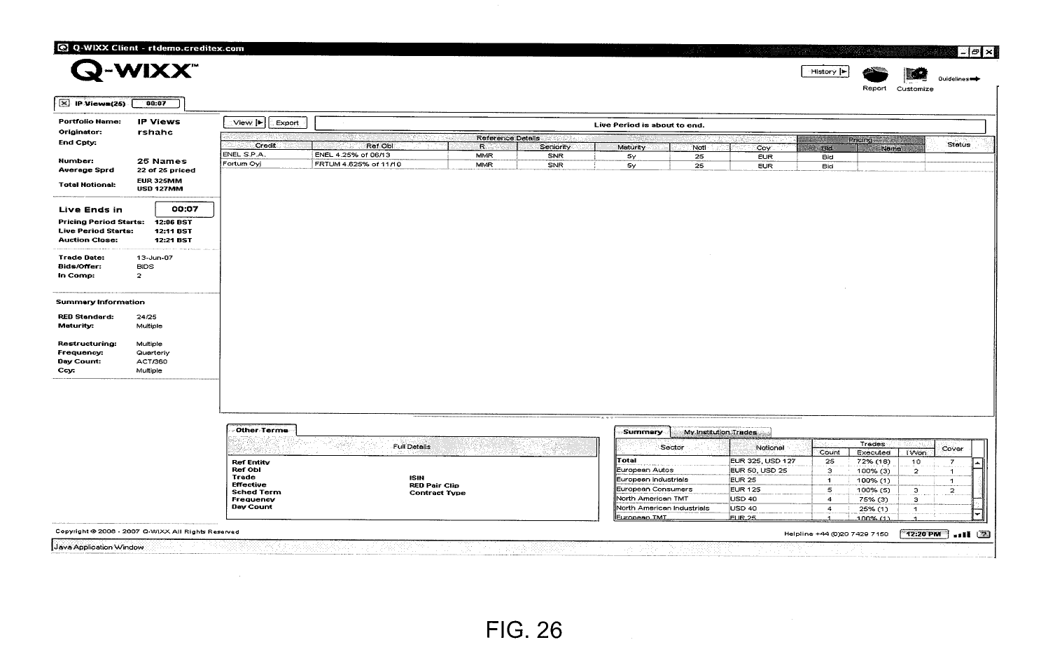

FIG. 23 shows a Bulk Execute view of the initiating counterparty main auction screen. This screen lists bulk executed trades. FIG. 24 shows a live view of the initiating counterparty main auction screen. This view shows credits that are still live. FIG. 25 shows an executed view of the initiating counterparty main auction screen. This view shows credits that have been executed. FIG. 26 shows a not yet priced view of the initiating counterparty main auction screen. This view shows credits that have not yet been priced by the dealers.

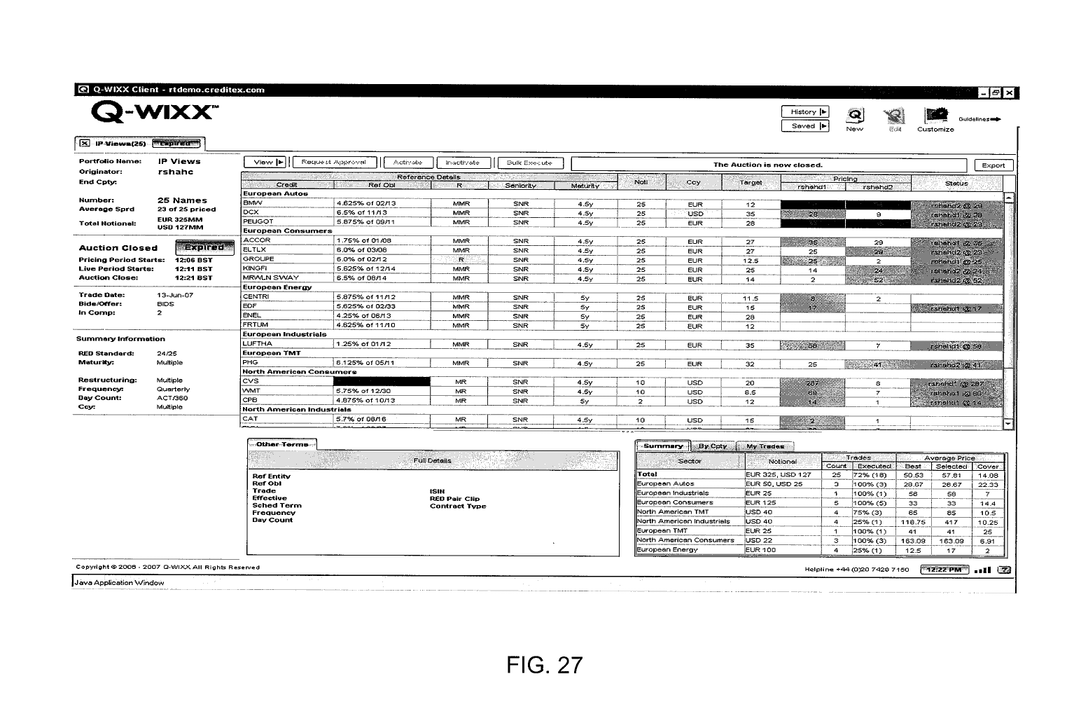

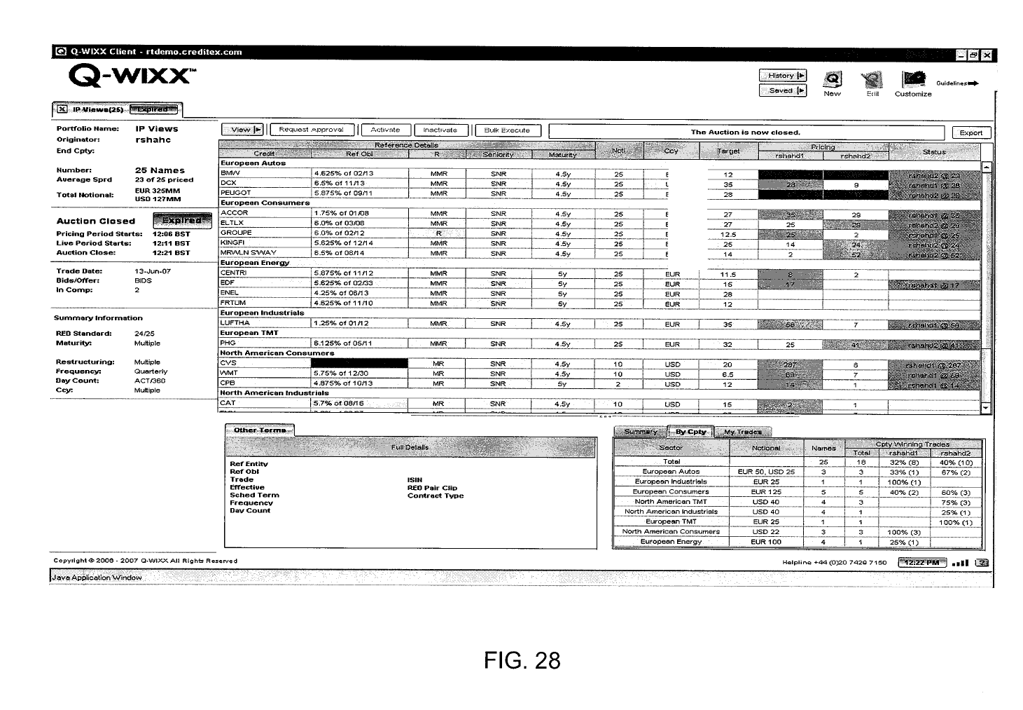

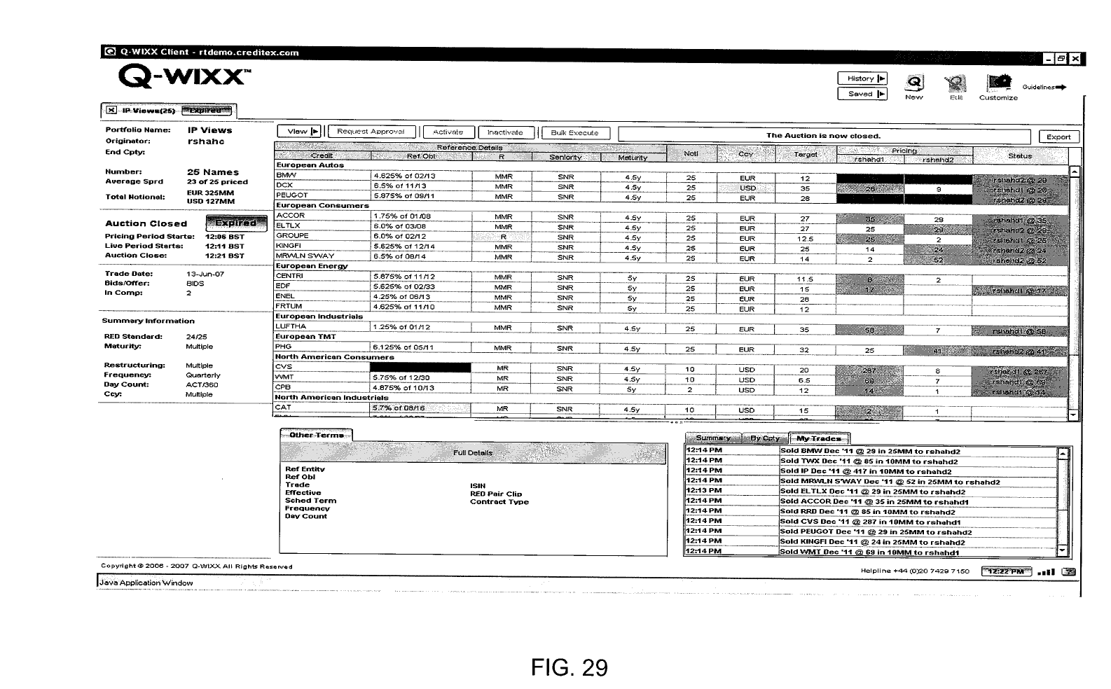

FIG. 27 shows a view of the initiating counterparty main auction screen with the Summary tab selected in the lower right corner. This tab shows a status summary of all of the listed CDS contracts by category. FIG. 28 shows a view of the initiating counterparty main auction screen with the By Counterparty tab selected in the lower right corner. This tab shows a summary of all trades won by each of the dealers. FIG. 29 shows a view of the initiating counterparty main auction screen with the My Trades tab selected in the lower right corner. This tab shows the trade tickets for all trades executed by the initiating counterparty in the auction that they are currently viewing.

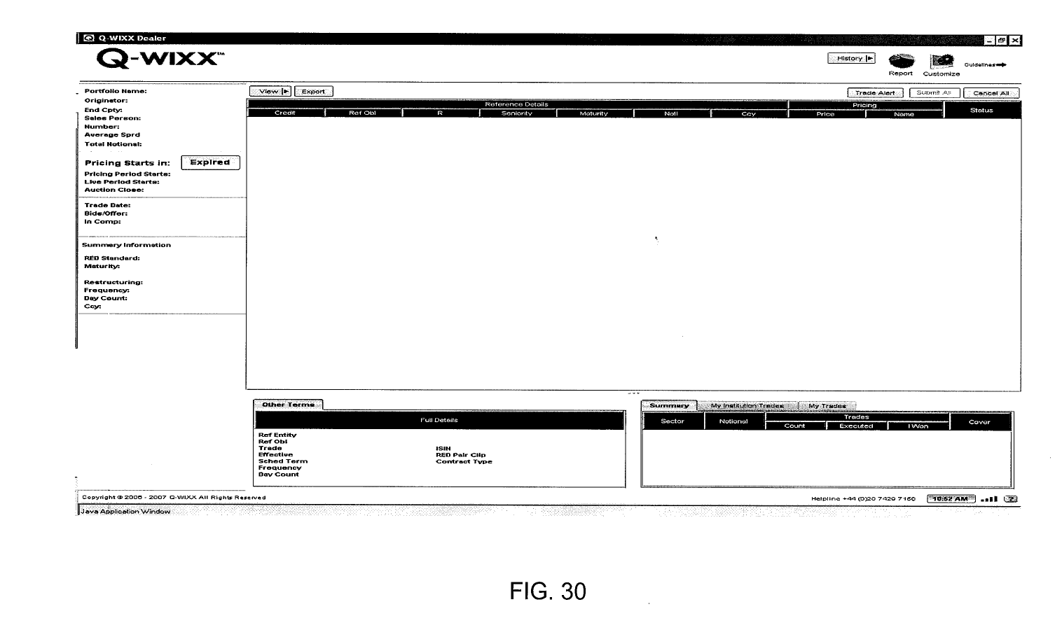

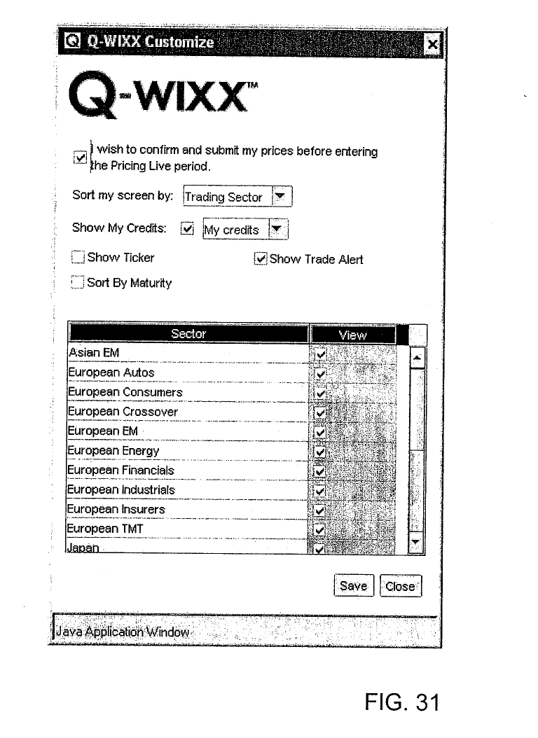

FIG. 30 is an example of a view of the dealer screen at least 10 minutes before the start of the Pricing Period. FIG. 31 shows a view of the screen when the dealer chooses the customize option. In this screen, the dealer has the option to input prices and then confirm that the prices are correct before they are posted to the platform. Only prices that have been confirmed prior to the end of the pricing period will be shown to the client. The dealer can also select how to sort the credits that appear on the screen, for example, by trading sector, alphabetically by reference entity, or by region and then alphabetically. The dealer may be able to create lists of credits on the platform known as custom display groups. Any custom display group may be used in the My Credits function. If an auction contains any credits in the custom display group and the functionality is switched on, then those credits will appear in a separate group at the top of the dealer's screen, and the remaining credits will then appear sorted and grouped in whatever way the dealer has selected (e.g. by trading sector). The dealer may be able to further sort by maturity.

The dealer can also choose whether to display: the full reference entity name of the credit on the screen in the main display area or the shortcode (Ticker); a pop-up box to alert dealer that they have been executed on trades; and a list of all valid platform trading sectors. Only credits in those sectors set to “View” may appear on the dealer's screen. Turning on a sector that is currently set to off will immediately display any credits in a list that were in this sector (i.e. it just controls what the dealer sees on the screen, not the access—dealers may always have the ability to see every credit in an auction).

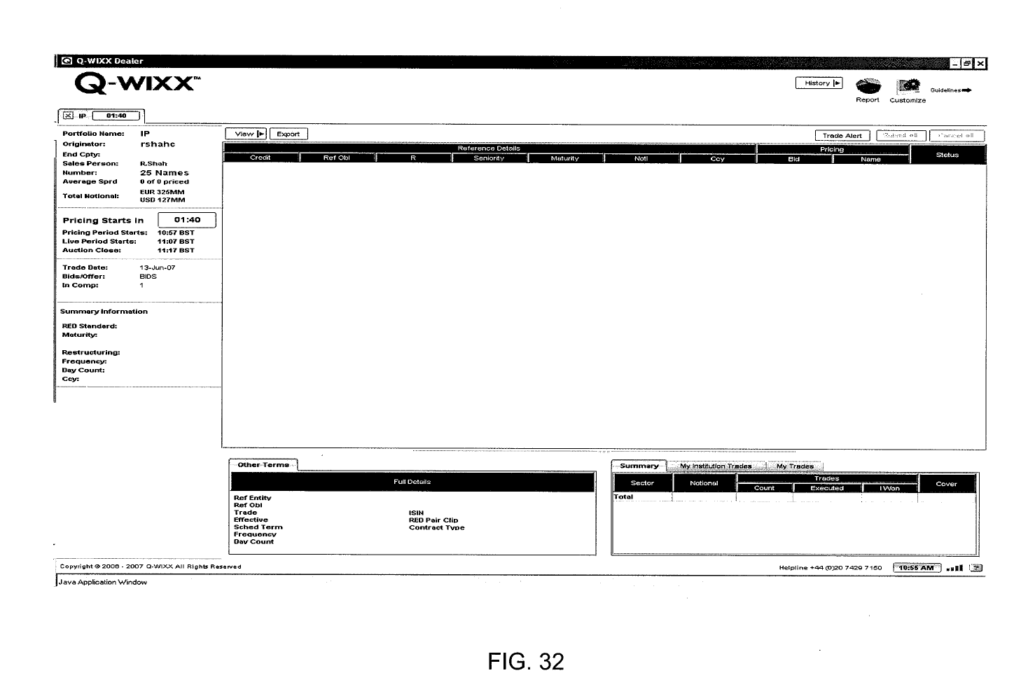

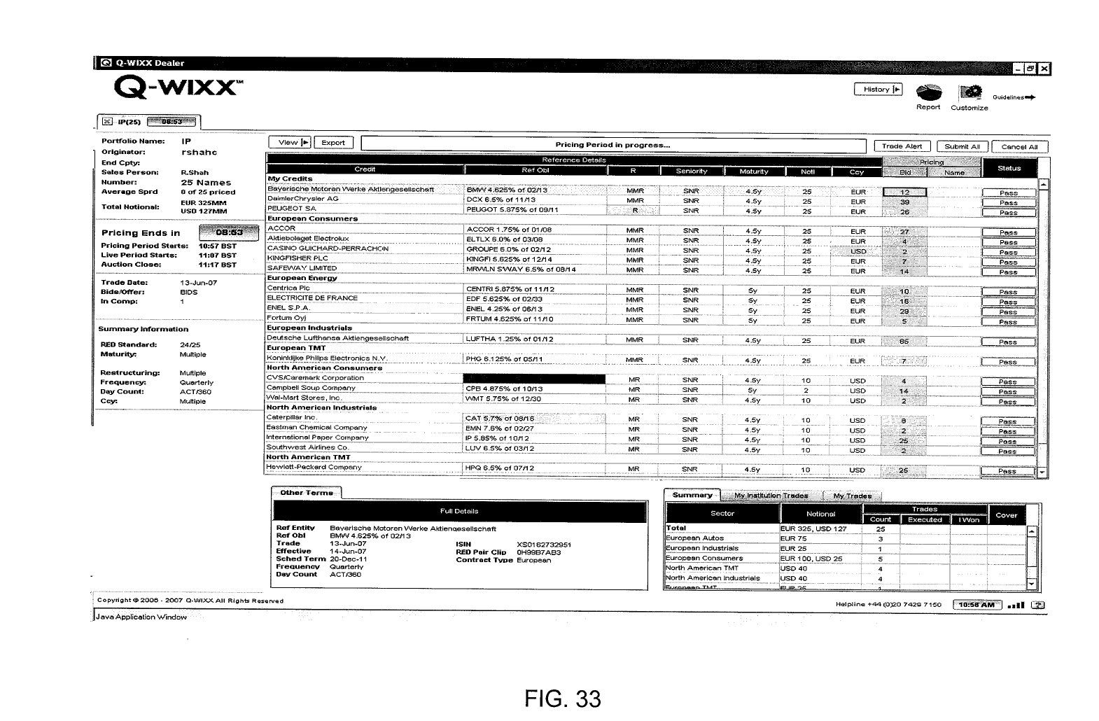

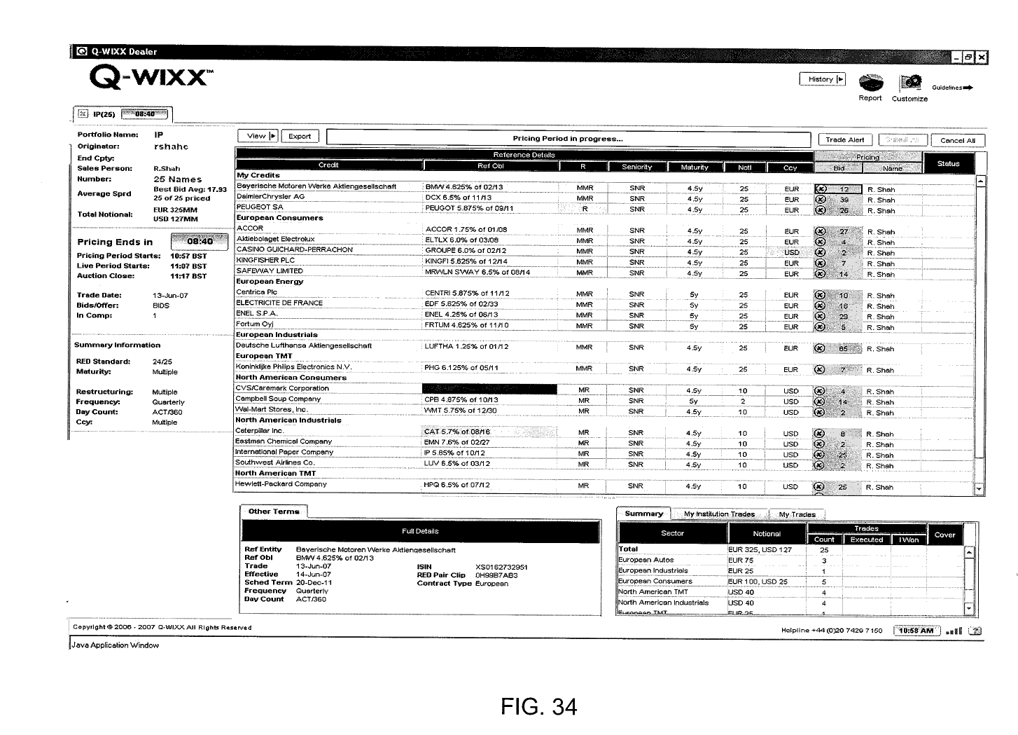

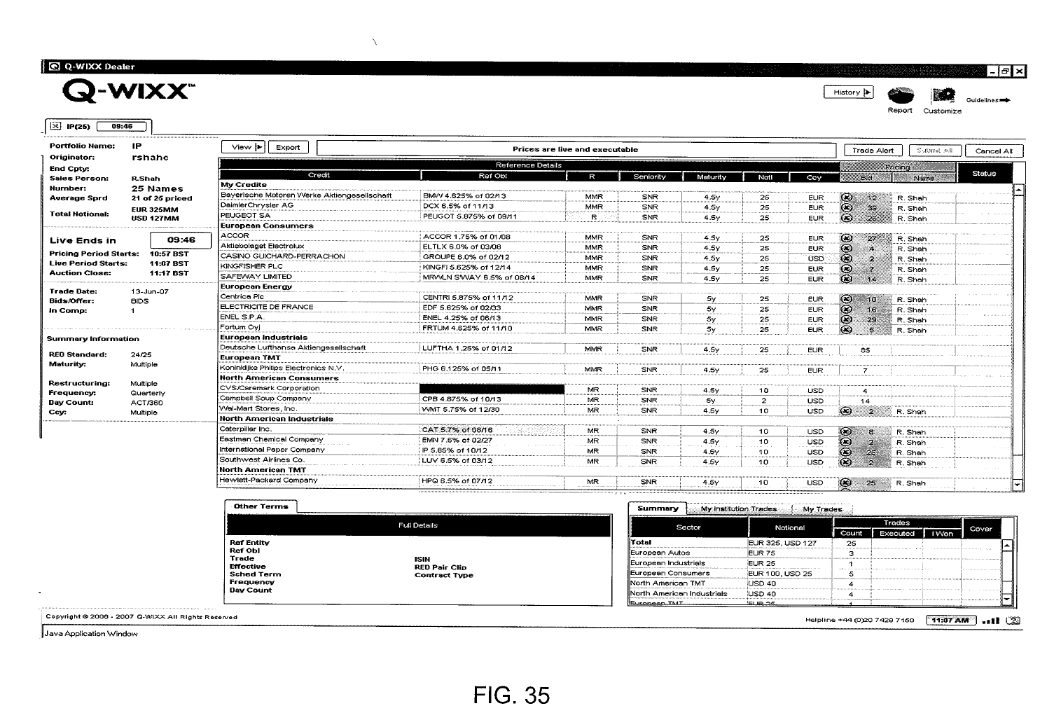

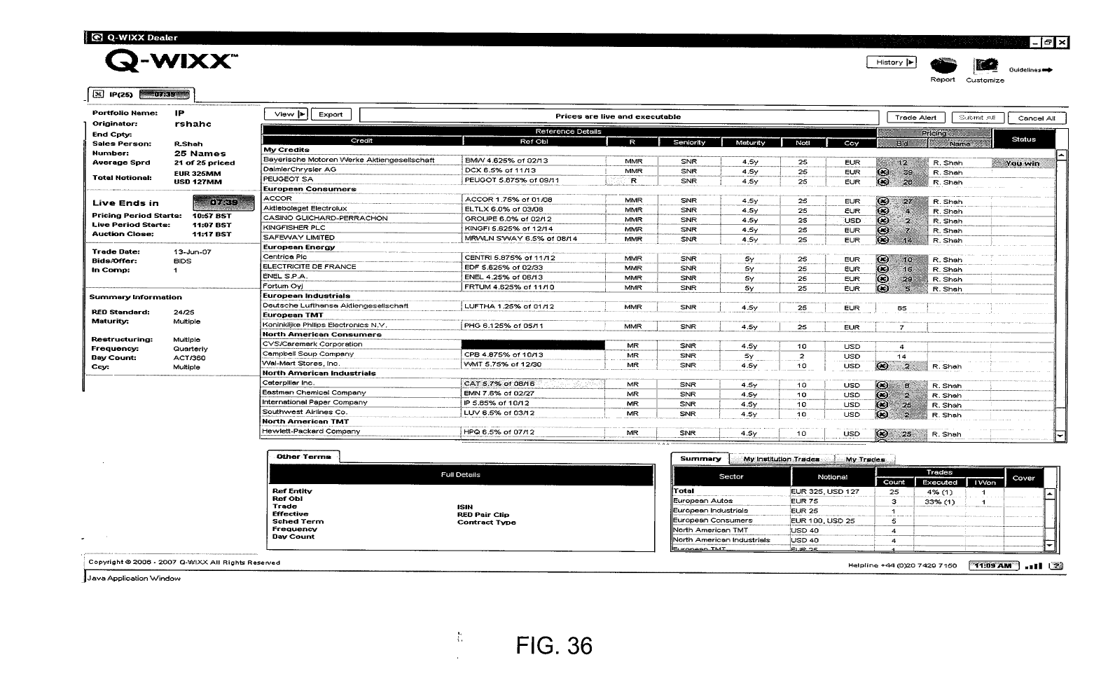

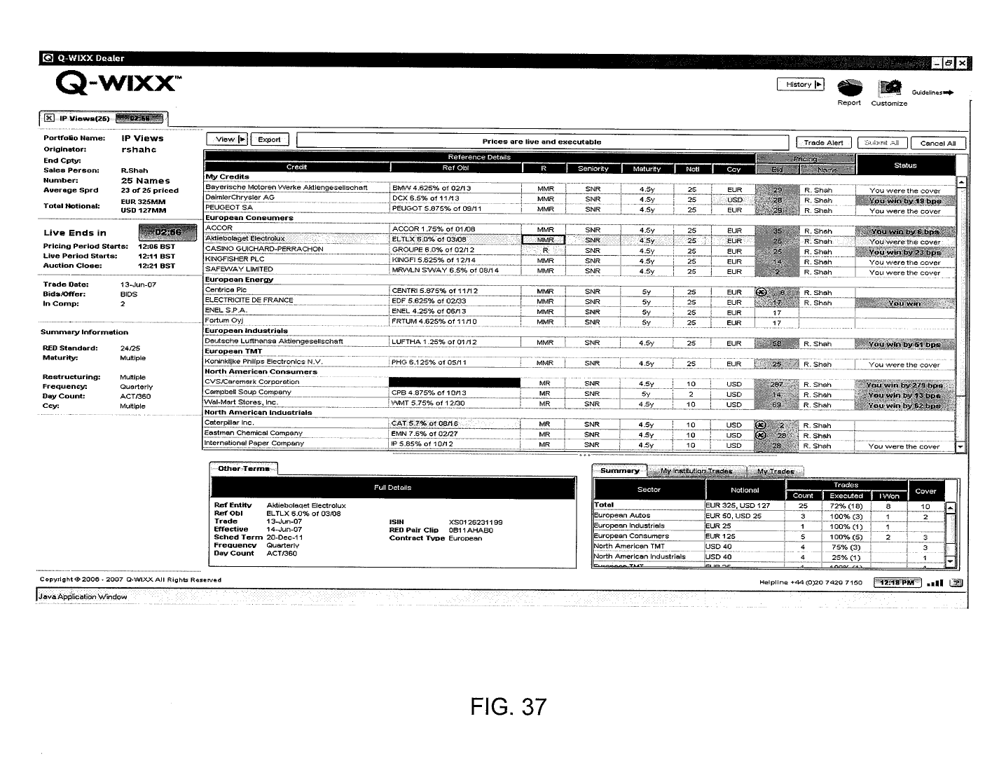

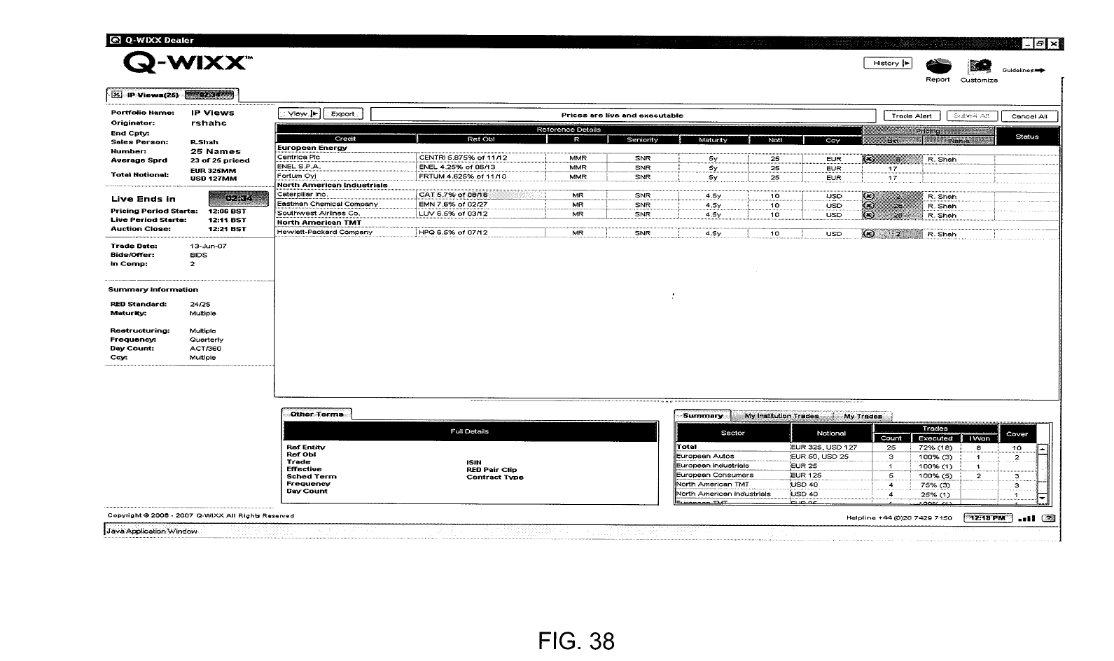

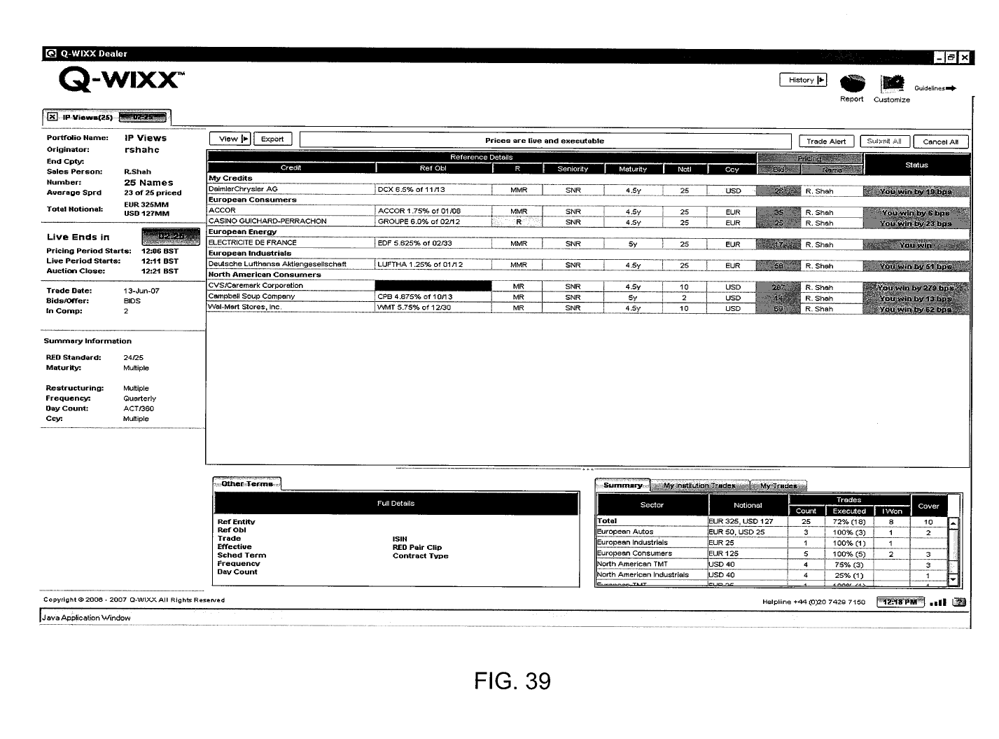

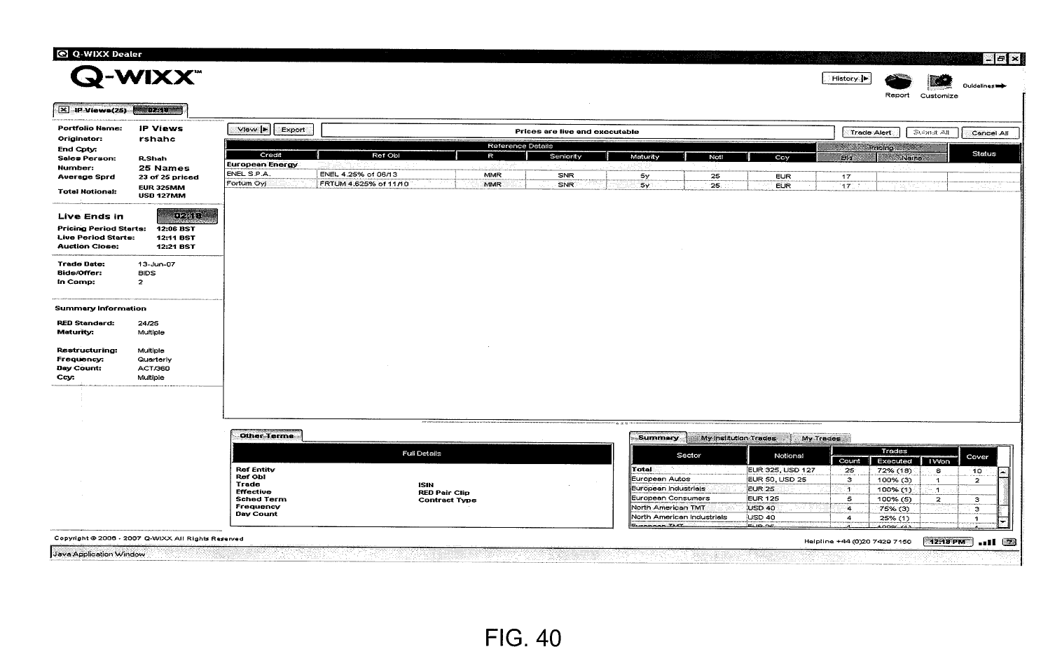

FIG. 32 is an example of a view of the dealer screen during the pre-pricing period with less than 10 minutes to the start of the Pricing Period FIG. 33 shows a view of the dealer screen during the pricing period with the dealers prices entered but not submitted. The submit all button is active. FIG. 34 shows a view of the dealer screen during the pricing period with the dealer's prices entered and submitted. FIG. 35 shows a view of the dealer screen during the live period with some prices passed/cancelled by the dealer. FIG. 36 shows a view of the dealer screen with an individual trade won by the dealer. FIG. 37 shows a view of the dealer screen following a bulk execution and includes multiple credits won by the dealer. FIG. 38 shows of a view of the dealer screen listing live prices during the live period. FIG. 39 shows a view of the dealer screen listing executed prices during the live period. FIG. 40 shows a view of the dealer screen listing credits that have not been priced during the live period.

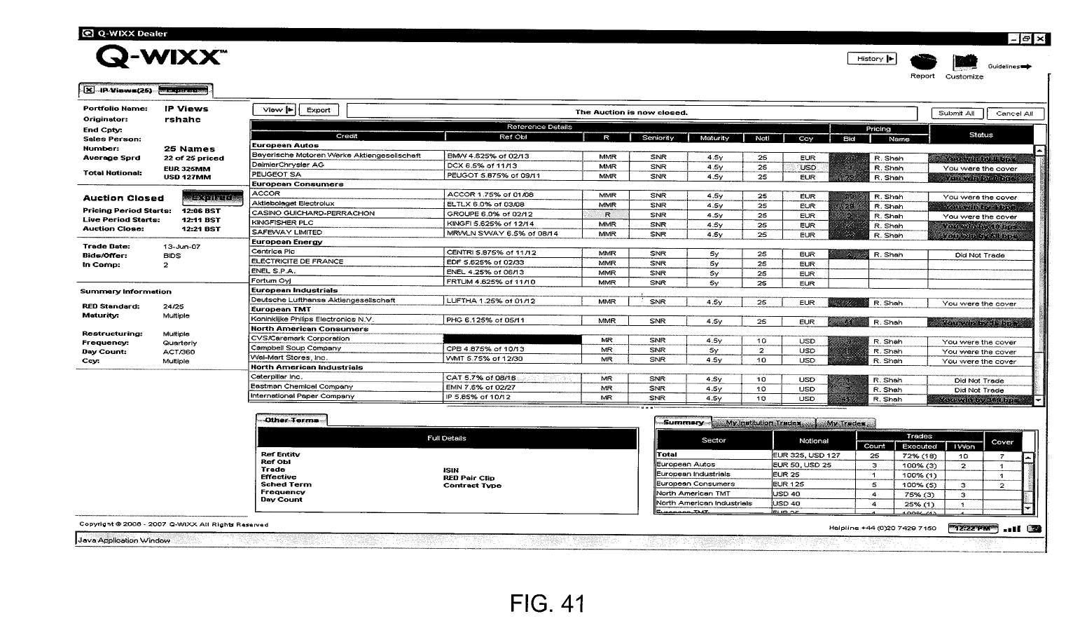

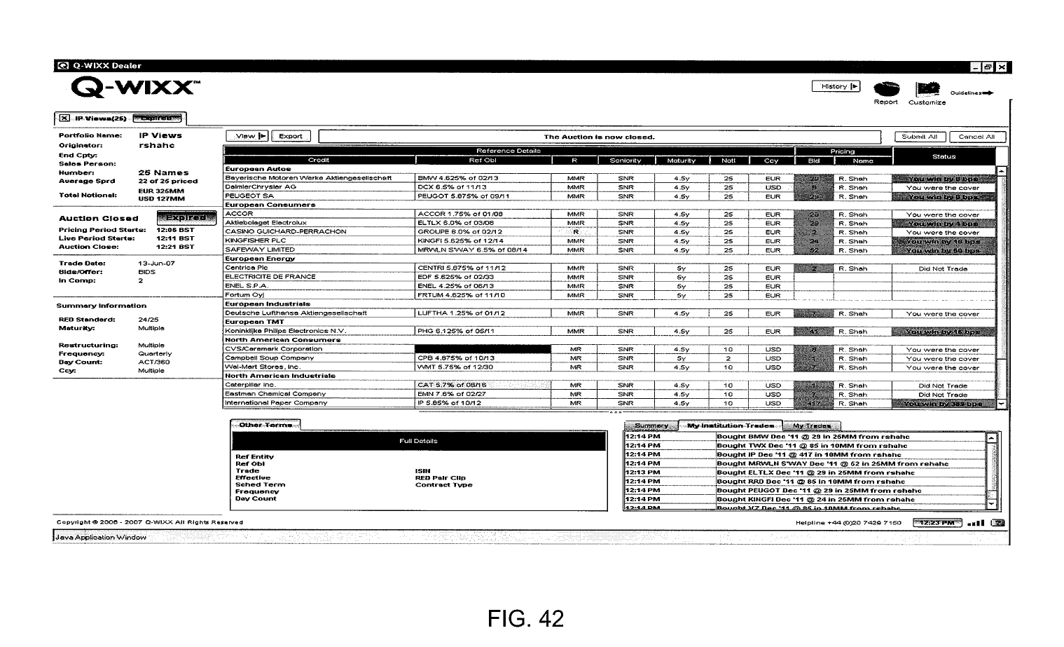

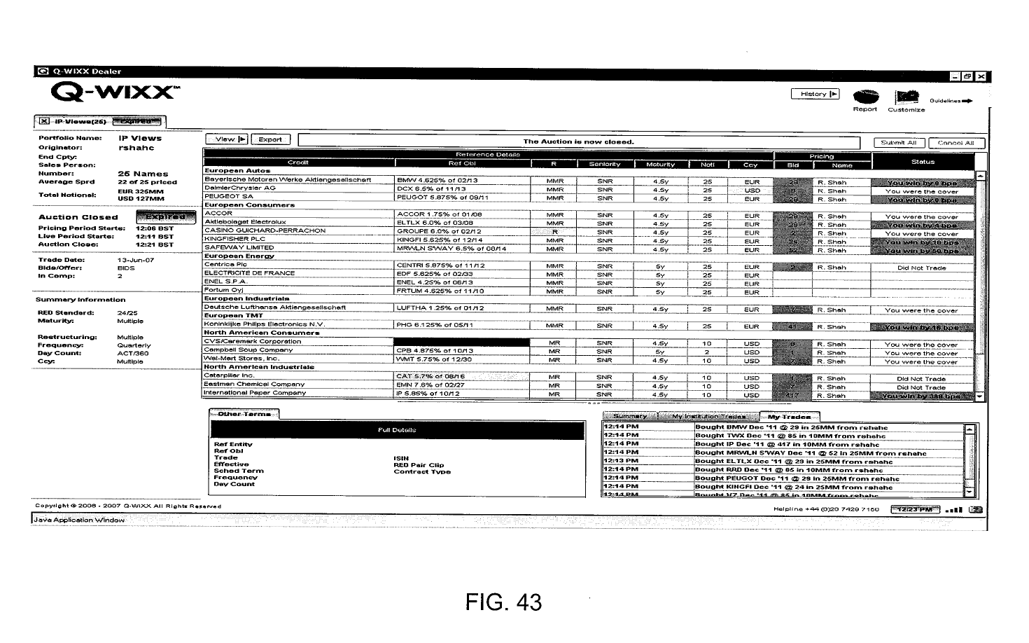

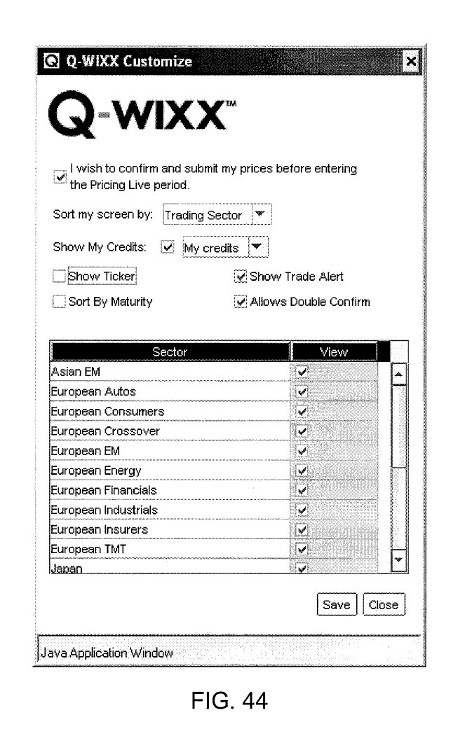

FIG. 41 shows a view of the dealer screen with the Summary tab selected in the lower right corner. This tab shows a status summary of all of the listed CDS contracts by category. FIG. 42 shows a view of the dealer screen with the My Institution Trades selected in the lower right corner. This tab shows a summary of all trades won by any of the traders associated with a dealer. FIG. 43 shows a view of the dealer screen with the My Trades tab selected in the lower right corner. This tab shows a summary of all trades won by the specific trader using the screen who is associated with the dealer.

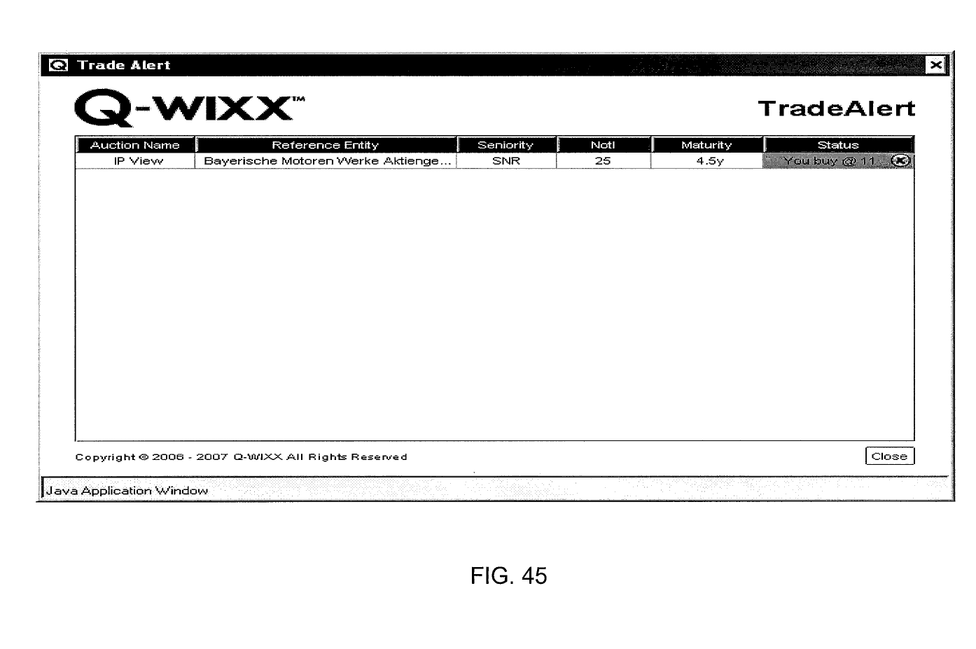

FIG. 44 shows a view of the Dealer Customize window with the double confirm option checked. The double confirm option allows the dealer the chance to back out of a trade after the trade has been executed. FIG. 45 shows a trade alert window that may appear on the dealer screen after a trade has been executed with the double confirm option checked. If the dealer is executed on multiple credits then they will queue up in the window. The dealer may click the red cross cancel button to indicate they are not able to stand up to the trade.

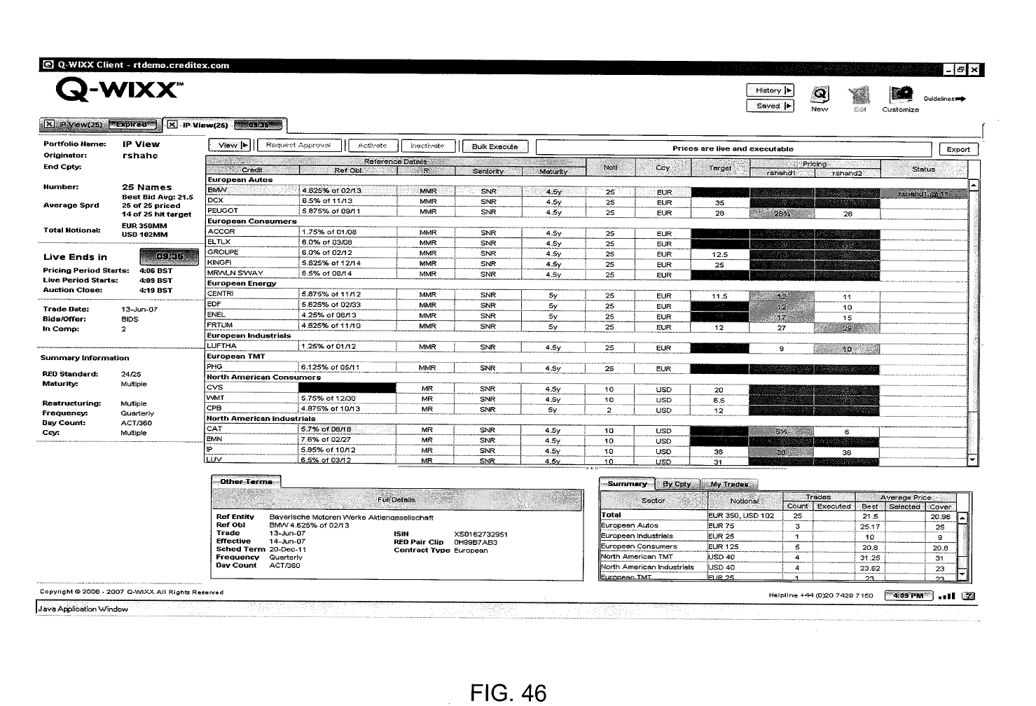

FIG. 46 shows a view of the initiating counterparty window after execution of a trade with a dealer that has the double confirmation functionality turned on. An orange cell background color indicates that the trade is not yet executed.

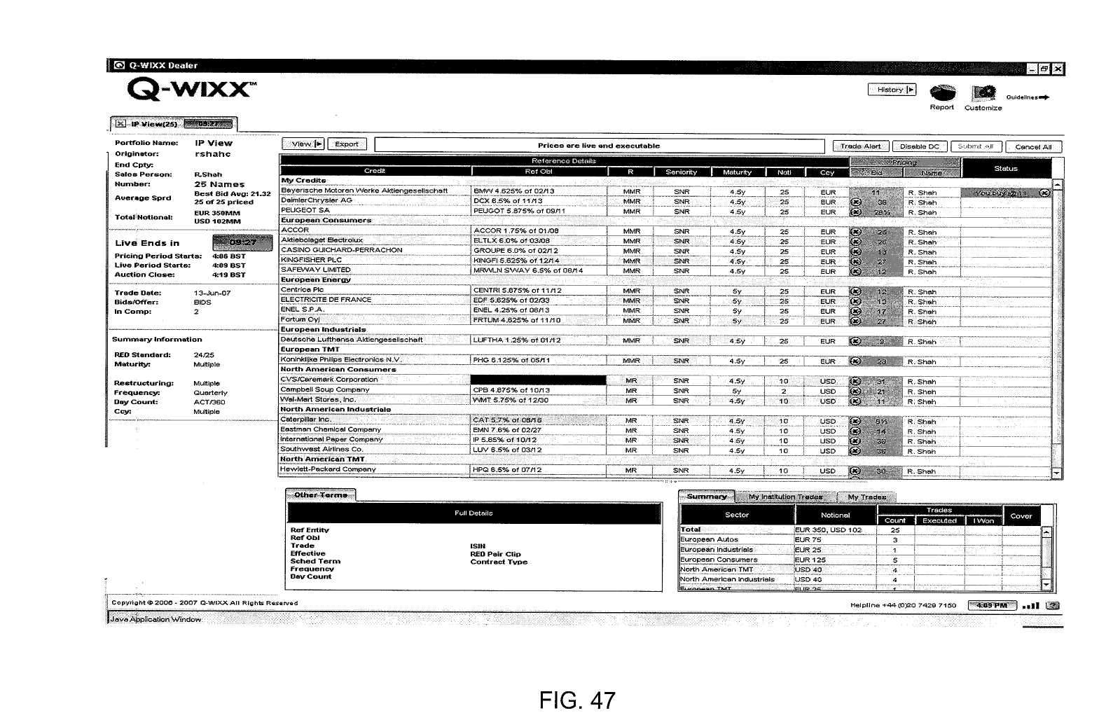

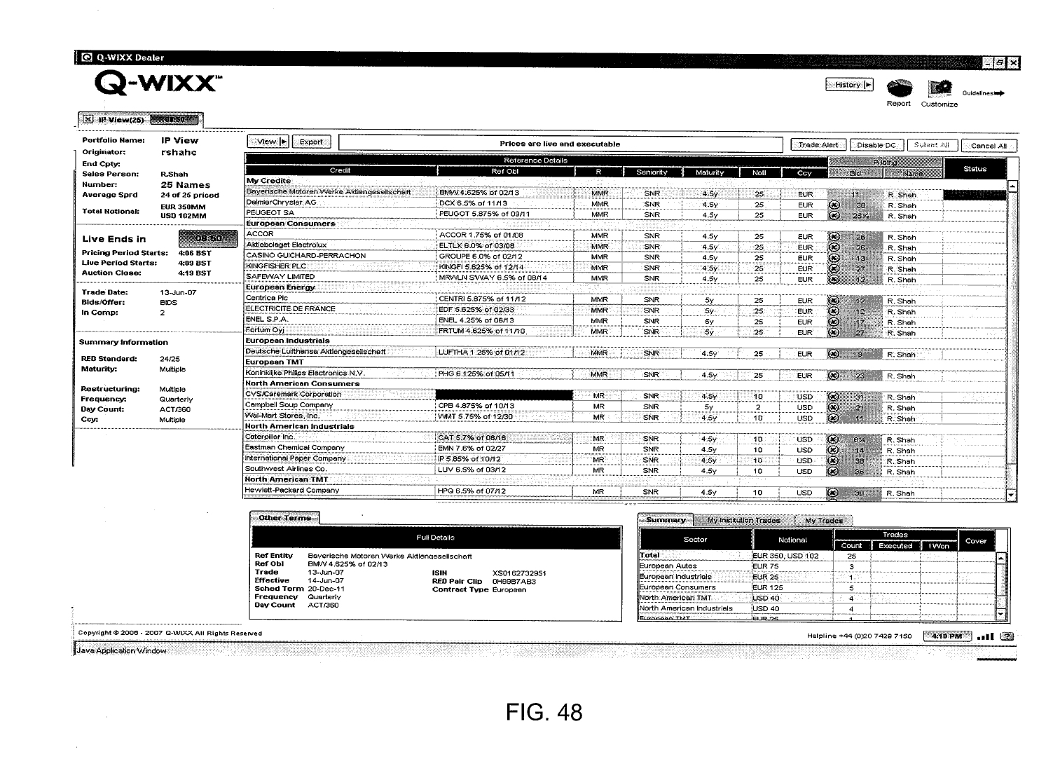

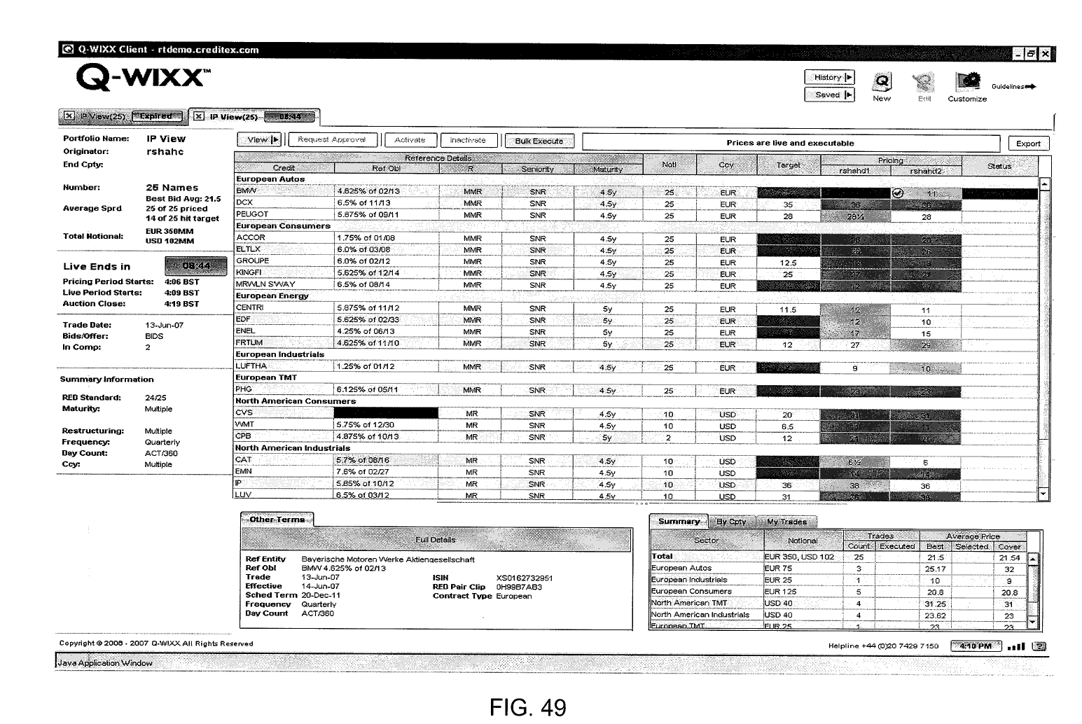

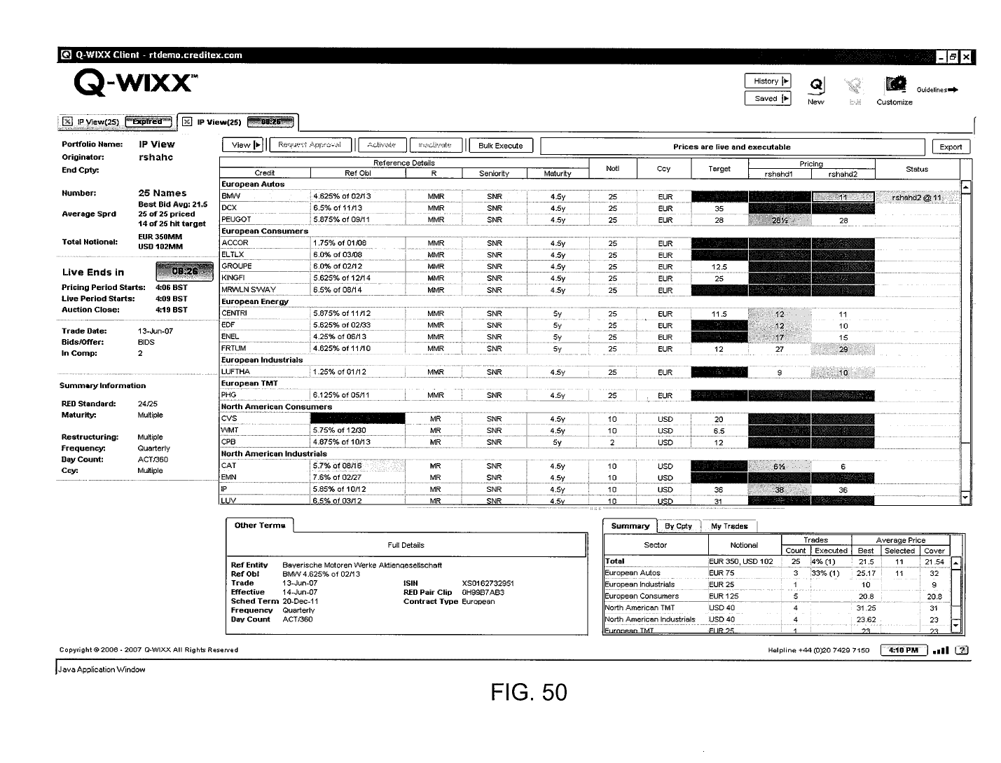

FIG. 47 shows a view of the dealer main screen after a trade has been executed with the double confirmation functionality turned on, but without the trade alert pop-up. FIG. 48 shows a view of the dealer main screen shown in FIG. 47 after the dealer has clicked on a cancel button to cancel a trade. FIG. 49 shows a view of the initiating counterparty screen after an executed trade has been cancelled by a dealer. The initiating counterparty sees that a trade has been cancelled in two ways—first, the price submitted by that dealer in their pricing column turns red, secondly the status column cell background turns red and indicates “Cancelled.” The initiating counterparty can now choose to execute on a price from another dealer. FIG. 50 shows a view of the initiating counterparty screen following execution of a trade with double confirmation turned off. In this case, the trade is immediately executed.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

Other embodiments and uses of the invention will be apparent to those skilled in the art from consideration of the specification and practice of the invention disclosed herein. All references cited herein, including all U.S. and foreign patents, patent applications, all publications and other documentary materials, are specifically and entirely hereby incorporated by reference.

1. An electronic auction method comprising:
providing an auction system comprising an administrative computing system in communication with at least one initiating counterparty system and at least one dealer system, said systems each comprising at least one server and at least one processor for executing electronic instructions, said administrative computing system performing the steps of:
receiving from an initiating counterparty system at least one identification of a plurality of credit default swap (CDS) contracts to be priced;
providing to a plurality of the dealer systems the identified CDS contracts to be priced;
electronically receiving bids from the dealer systems for one or more of the identified CDS contracts during a pricing period portion of the electronic auction that is a pre-agreed period of time;
receiving from the initiating counterparty system an electronic instruction to execute one or more of the bids; and
simultaneously executing said one or more bids according to the electronic instruction.

2. The method of claim 1, further comprising one or more of the dealer systems requesting an opportunity to improve a bid for a CDS contract once all bids for the CDS contract have been accepted.

3. The method of claim 1, wherein the electronic instruction to execute one or more of the bids from the initiating counterparty system occurs during a live period portion of the electronic auction that is a pre-agreed period of time occurring after the pricing period portion.

4. The method of claim 1, wherein at least one dealer system cancels a bid after the electronic instruction to execute the bid has been accepted from the initiating counterparty system.

5. The method of claim 2, wherein the initiating counterparty system selectively transmits an electronic instruction enabling one or more of the dealer systems to submit an improved bid for a CDS contract after bids for the CDS contract have been accepted from the dealer systems.

6. The method of claim 5, further comprising receiving an improved bid electronically from one or more dealer systems.

7. The method of claim 1, further comprising receiving from the initiating counterparty system an electronic instruction assigning all executed transactions to an end-counterparty system.

8. The method of claim 1, further comprising electronically notifying the dealer systems that a list of CDS contracts to be priced has been received, prior to providing to the dealer systems the identified CDS contracts to be priced.

9. An electronic auction method comprising:
providing an auction system comprising an administrative computing system in communication with at least one initiating counterparty system and at least one dealer system, said systems each comprising at least one server and at least one processor for executing electronic instructions, said administrative computing system performing the steps of:
receiving from an initiating counterparty system an identification of a plurality of credit default swap (CDS) contracts to be priced;
providing to a plurality of the dealer systems the identified CDS contracts to be priced;
electronically receiving offers from the dealer systems for one or more of the identified CDS contracts during a pricing period portion of the electronic auction that is a pre-agreed period of time;
receiving from the initiating counterparty system an electronic instruction to execute one or more of the offers; and
simultaneously executing said one or more offers according to the electronic instruction.

10. The method of claim 9, further comprising one or more of the dealer systems requesting an opportunity to improve an offer for a CDS contract once all offers for the CDS contract have been accepted.

11. The method of claim 9, wherein the electronic instruction to execute one or more of the offers from the initiating counterparty system occurs during a live period portion of the electronic auction that is a pre-agreed period of time occurring after the pricing period portion.

12. The method of claim 9, wherein at least one dealer system cancels an offer after the electronic instruction to execute the offer has been accepted from the initiating counterparty system.

13. The method of claim 9, wherein the initiating counterparty system selectively transmits an electronic instruction enabling one or more of the dealer systems to submit an improved offer for a CDS contract after offers for the CDS contract have been accepted from the systems.

14. The method of claim 13, further comprising receiving an improved offer electronically from one or more systems.

15. The method of claim 9, further comprising receiving from the initiating counterparty system an electronic instruction assigning all executed transactions to an end-counterparty system.

16. The method of claim 9, further comprising electronically notifying the dealer systems that a list of CDS contracts to be priced has been accepted, prior to providing to the dealer systems the identified CDS contracts to be priced.

17. An auction system comprising:
an administrative computing system in communication with an initiating counterparty computing system and a plurality of dealer computing systems, wherein the administrative computing system is configured to receive an identification of a plurality of credit default swap (CDS) contracts to be priced from the initiating counterparty computer system and is configured to receive bids for one or more of the identified CDS contracts from one or more of the dealer computer systems.

18. The system of claim 17, wherein the administrative computing system is in communication with the initiating counterparty computing system and a plurality of dealer systems using an Internet connection.

19. An auction system comprising:
an initiating counterparty system comprising an initiating counterparty interface configured to receive from an initiating counterparty an identification of a plurality of credit default swap (CDS) contracts to be priced; and
a plurality of dealer systems comprising a dealer interface configured to provide the identified CDS contracts to be priced and configured to receive prices form dealers for the identified CDS contracts.

20. The system of claim 19, further comprising an administrative system in communication with the initiating counterparty system and the plurality of dealer systems.
